(19) United States
(12) Patent Application Publication
(10) Pub. No.: US 2017/0334081 A1
(43) Pub. Date: Nov. 23, 2017

(54) TWO-SIDED BODY SHAVER

(71) Applicant: Dryfhout Enterprises, LLC, Frankfort, IL (US)

(72) Inventor: Matthew James Dryfhout, Frankfort, IL (US)

(73) Assignee: Dryfhout Enterprises, LLC, Frankfort, IL (US)

(21) Appl. No.: 15/156,875

(22) Filed: May 17, 2016

(51) Int. Cl. B26B 21/44; A45D 27/04; B26B 21/40; B26B 21/52

(52) U.S. Cl. CPC B26B 21/44; B26B 21/523; B26B 21/522; A45D 27/04; B26B 21/4031; B26B 21/4081

(57) ABSTRACT

A two-sided back shaver handle has an elongated member. A blade attachment located on the inner side is at a blade end of the elongated member opposite a grip end. A sponge is wrapped around the elongated member on the outer side of the elongated member opposite a grip end. The sponge has a strap wrapped around the elongated member. An elongated sponge can be located in a direction along a length of the elongated member on an outer side, wherein the elongated sponge extends longer in a length between the grip and the blade end than a width between the left side and the right side. The elongated member can be s-shaped with a convex surface contour on the outer side between the grip and the blade end.

### BACKGROUND OF THE INVENTIONS

### 1. Technical Field

The present inventions relate shavers and, more particularly, relate to a multifunctional handled body shaver.

### 2. Description of the Related Art

More recently, it has become very popular for men to shave their back side or body. However, it is commonly known that it can be challenging for an individual to access their own back side when shaving. It is because of this challenge that many men often recruit a partner to shave their back side. Since a partner may not always be an option a user often either pays to have their hair removed professionally or they often purchase a do-it-yourself elongated back shaver. In order to shave one's backside or body one conventionally resorts to using an elongated handle that is attached to a blade wherein the handle is curved or angled in order to allow the user to meet their back side with the blade. Often times these elongated handles are shaped with a slight curve or even jagged angles in order to ensure the blade will meet the back side.

Applicators have been combined with shavers to enhance shaving. It would be beneficial to have an elongated handle for shaving one's own back with an improved configuration for an applicator combined with a shaver blade.

### BRIEF DESCRIPTION OF THE DRAWINGS

The present inventions are illustrated by way of example and are not limited by the accompanying figures, in which like references indicate similar elements. Elements in the figures are illustrated for simplicity and clarity and have not necessarily been drawn to scale.

The details of the preferred embodiments and these and other objects and features of the inventions will be more readily understood from the following detailed description when read in conjunction with the accompanying drawings wherein:

FIG. 1 illustrates a side view of a two-sided back shaver handle with a sponge and a safety razor configured according to embodiments of the present inventions;

FIG. 2 illustrates a perspective end view looking from an handle end of a two-sided back shaver handle with a sponge and a safety razor configured according to embodiments of the present inventions;

FIG. 3 illustrates an aerial view of a two-sided back shaver handle gripped by a user extended under the armpit towards the backside according to embodiments of the present inventions;

FIG. 4 illustrates an aerial view of a two-sided back shaver handle gripped by a user extended under the armpit towards the backside according to embodiments of the present inventions;

FIGS. 5-6 illustrate aerial views of handles gripped by a user extended under the armpit towards the backside with two blade groups indenting into the skin surface and triggering a sensory system according to embodiments of the present inventions;

FIG. 7 illustrates a cross-section of a blade group according to embodiments of the present inventions;

FIG. 8 illustrates a cross-section of a blade group pressing into skin according to embodiments of the present inventions;

FIG. 9 illustrates a top view of a wrist area for a user according to embodiments of the present inventions;

FIGS. 10-12 illustrate front views of user utilizing a two-sided back shaver handle according to embodiments of the present inventions;

FIGS. 13-15 illustrate side views of a user utilizing a two-sided back shaver handle according to embodiments of the present inventions;

FIG. 16 illustrates a front view of a blade end of an elongated member according to embodiments of the present inventions;

FIGS. 17-19 illustrate aerial views of a user utilizing an elongated member according to embodiments of the present inventions;

FIGS. 20-22 illustrate side views of a two-sided back shaver handle configured with a soft cushion or sponge and a blade on an opposing side gripped by a user extended under the armpit towards the backside according to embodiments of the present inventions.

FIGS. 23-24 illustrate a side view of a two-sided back shaver handle with a hinge, a pull trigger and constituent parts of a handle according to embodiments of the present inventions;

FIGS. 25-26 illustrate side views of a two-sided back shaver handle with a hinge, a push button constituent parts of handle according to embodiments of the present inventions;

FIG. 27 illustrates a rearview cutaway midway the two-sided back shaver handle according to embodiments of the present inventions;

FIG. 28 illustrates a rearview cutaway midway the beginning of the grip and the handle end according to embodiments of the present inventions;

FIG. 29 illustrates a rearview of a folded two-sided back shaver handle according to embodiments of the present inventions;

FIG. 30 illustrates a side view of a folded two-sided back shaver handle according to embodiments of the present inventions;

FIG. 31 illustrates a side view of a folded two-sided back shaver handle being grasped by a user's hand according to embodiments of the present inventions;

FIG. 32 illustrates a front view of a user grasping a folded two-sided back shaver handle and shaving according to embodiments of the present inventions;

FIG. 33 illustrates a side view of a two-sided back shaver handle and further illustrating degrees of angle between two-sided back shaver handle and a flat plane according to embodiments of the present inventions; and

FIG. 34 illustrates a side view of an elongated member with an elongated sponge and a safety razor configured according to embodiments of the present inventions.

### DETAILED DESCRIPTION OF THE PREFERRED EMBODIMENTS

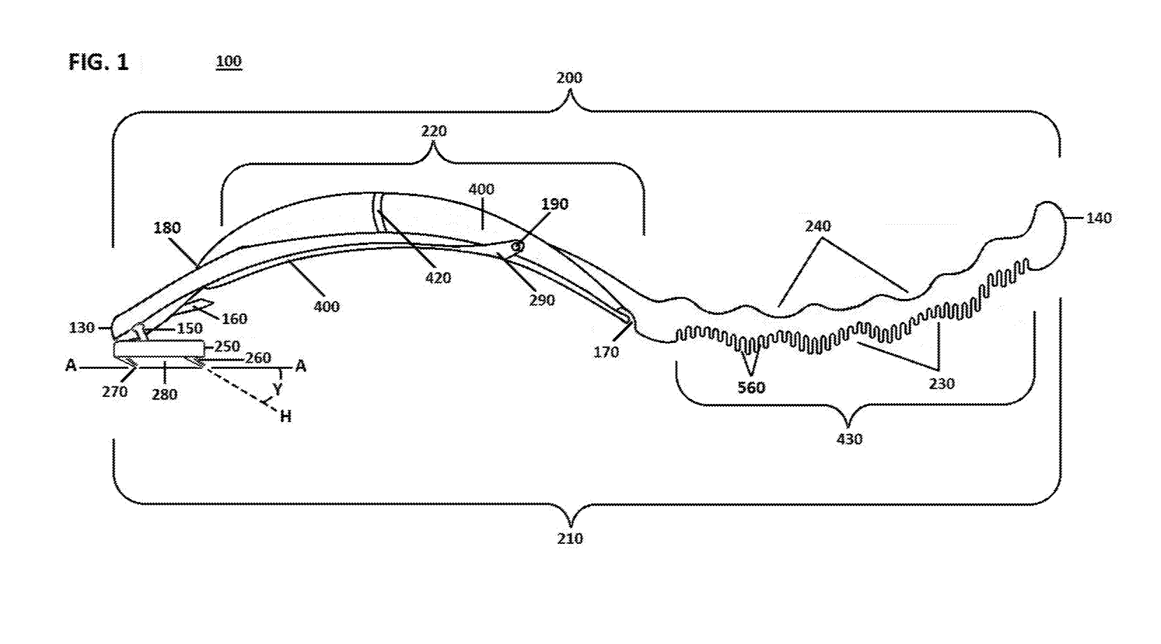

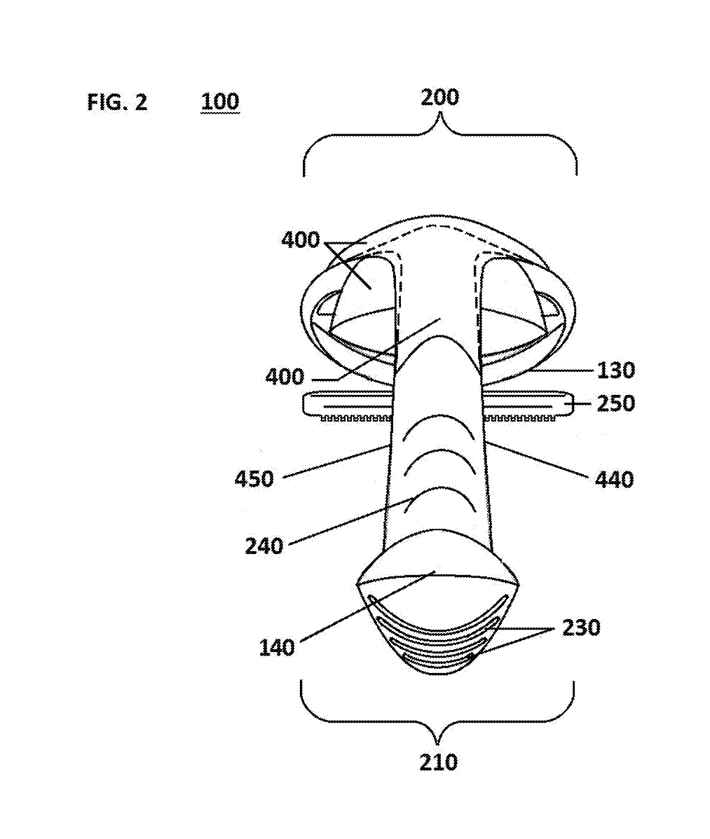

FIG. 1 illustrates a side view of a two-sided back shaver handle with a sponge and a safety razor configured according to embodiments of the present inventions. In FIG. 1 an elongated member with an elongated sponge 400 and a safety razor 250 is illustrated. The elongated member has an elongated member 100 having a surface along a length of the elongated member 100 defining an inner side 210 and an outer side 200, a blade end 130 and a grip end 140 and a left side and a right side which will be further illustrated in the upcoming FIG. 2. The outer side 200 is opposite the inner side 210. The grip end 140 is opposite the blade end 130 and between the outer side 200 and the inner side 210. The outer side 200, the inner side 210, the blade end 130, the grip end 140 join one another to create an outside surface of the elongated member 100 that is substantially smooth and a cross-sectional shape of the elongated member near the midway is substantially smooth having a shape that is substantially round or oval and a blade attachment 150 at a blade end 130 of the elongated member 100 opposite the grip end 140. The blade attachment 150 is a portion of the elongated member 100 near the blade end 130 that attaches to an attachment on the safety razor 250. In order for the blade attachment 150 to properly function there is also an attachment on the safety razor 250 for the elongated member 100 to attach itself to. The blade attachment 150 and a attaching piece on the safety razor may take many different forms to allow both safety razor 250 and elongated member 100 to removably attach with one another.

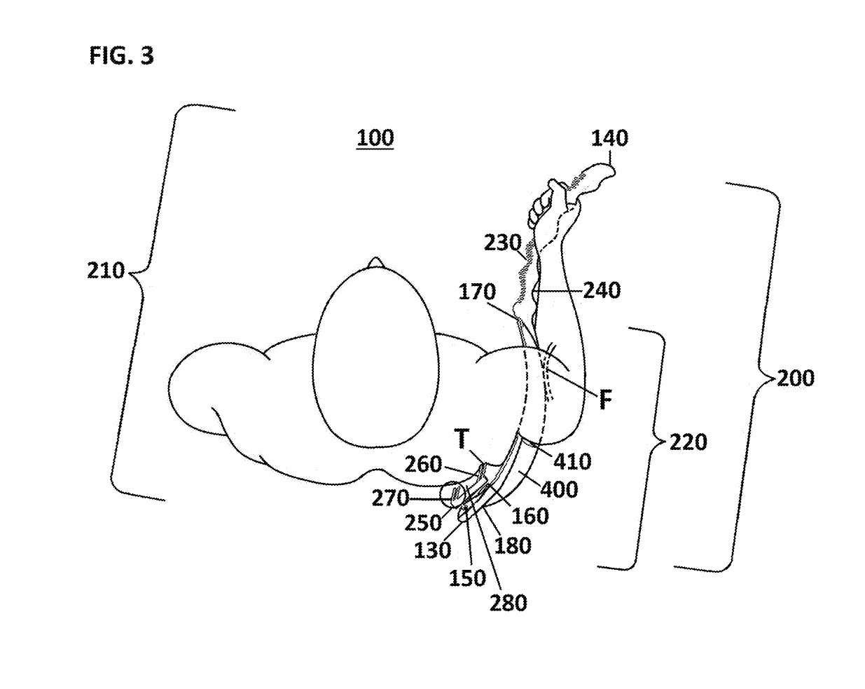

The blade attachment 150 at the blade end 130 of the elongated member 100 and comprises a handle clip 160 used to lock and release the safety razor 250 in the blade attachment 150. The blade end 130 located at an end of elongated member opposite the grip end 140. The blade attachment 150 located on the inner side 210 of the elongated member 100. As previously stated said left side and said right side will be clearly illustrated in the upcoming second embodiment in FIG. 2. The blade attachment 150 attaches to the safety razor 250 with at least a first blade group 260 on the inner side 210 of the elongated member facing against the torso backside of the user. In FIG. 1 we see more than one blade group 260 illustrated which grants the ability to perform two-point discrimination which will be further described and illustrated in FIGS. 3-8. Primary blade group 260 and secondary blade group 270 are positioned at an angle in relation to the safety razor 250 and may be positioned at a wide range of angles. A midpoint of a sharp blade 110 that is non-flexing is referenced as midpoint H and is illustrated as a dashed line in FIG. 1.

Primary blade group 260 and secondary blade group 270 are designed to safely poke and indent into a skin surface in order to carry out an effective shaving stroke while at the same time performing two-point discrimination. Furthermore, a sensory gap 280 is illustrated in FIG. 1 is a gap of space inside of two supports. The blade group 260 and blade group 270 create a balanced shaving angle between the safety razor 250 and a skin plane A. In FIG. 1 a midpoint of a portion of a non-flexing sharp blade 110 is referenced as midpoint H. The angle between a flat skin plane A in relation to midpoint H is preferably 35 degrees or less. If there were only blade group 260 and blade group 270 was absent then the blade group 260 would shift from side to side. Since blade group 270 is present blade group 260 and blade group 270 balance each other at the correct cutting angle. In FIG. 1 it can be seen that blade group 260 and secondary blade group 270 take the form of a support needed to create sensory gap 280. Sensory gap 280 may have a deep gap or a shallow gap. The distance of sensory gap 280 between a pair of supports will vary. The first purpose is to allow balance and stability of the safety razor 250 when stroking against the skin surface A. Sensory gap 280 also grants space for a tightened skin to convex and enter inside of sensory gap 280 allowing a user to maintain an effective angle between blade groups and a skin surface without difficulty. The sensory gap 280 also creates an effective amount of distance between primary blade group 260 and secondary blade group 270 in order to allow two-point discrimination to occur which will be further described in the upcoming FIGS. 3-8.

The elongated sponge 400 is located on the outer side 200 of the elongated member closer to the blade end 130 than the grip end 140. As seen in FIG. 1, when the elongated sponge 400 is wrapping itself around the elongated member 100 a portion of the elongated sponge 400 may be presented on the inner side 210 and the outer side 200 of the elongated handle 100 as well. The elongated sponge 400 is centered near a midway between the grip 230 or 240 and the blade attachment 150 on the outer side 200 of the elongated member. In a preferred embodiment the elongated sponge 400 has a uniform thickness. Although it is preferred to have a uniform thickness, other levels of thickness will work. A cross-sectional shape of the elongated member near a midway is substantially smooth having a shape that is substantially round or oval. The elongated member may be generally s-shaped with a convex surface contour on the outer side 200 between the grip 230 and the blade end 130. The elongated sponge 400 has a shape that conforms to the convex surface contour of the outer side 200 of the elongated member 100. The elongated sponge 400 in FIG. 1 comprises at least one strap 290 for attachment on the elongated member. The strap 290 may be of elastic or an alternative material that may stretch when pulled. In FIG. 1 the elongated member comprises a hook anchor 170 and a snap button 190 located to catch the strap 290 for attachment of the elongated sponge 400. A pocket 410 is illustrated in FIG. 1 and embodied on said elongated sponge 400 in order to allow a user the option to harness a solid bar of soap inside of said elongated sponge 400 in order to create a lather when applying water and stroking the elongated sponge 400 against the backside. The elongated sponge 400 has characteristics capable of holding a skin care product. It also be noted that the portion of the elongated handle 100 that is being covered by said elongated sponge 400 is represented by a dashed line inside the elongated sponge 400.

The elongated member 100 has a straight line length measured directly from the from the blade end 130 to the grip end 140 of about 330 mm to about 457.2 mm. A preferred straight line length of the elongated member 100 is approximately 355.6 mm. This straight line length is measured across in a straight line from end to end, not following the curve of the elongated member 100.

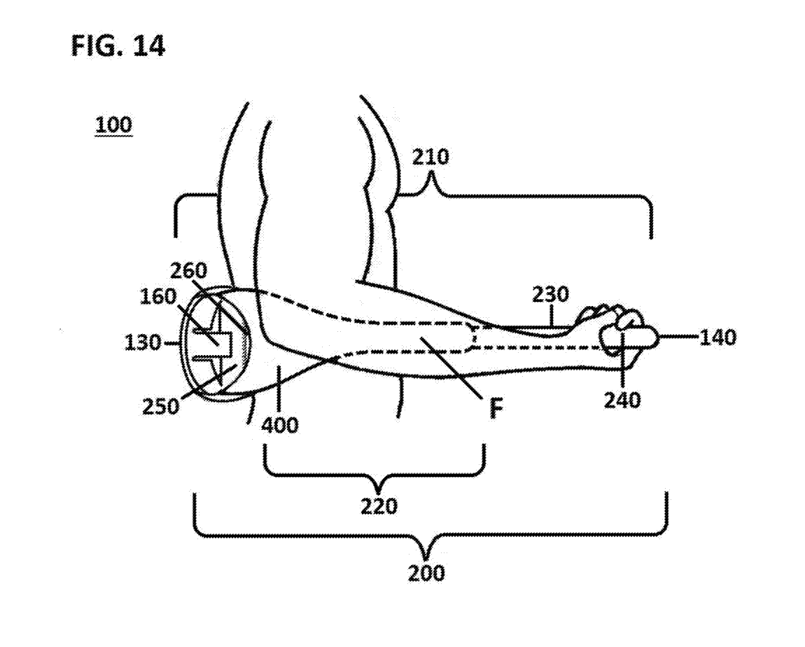

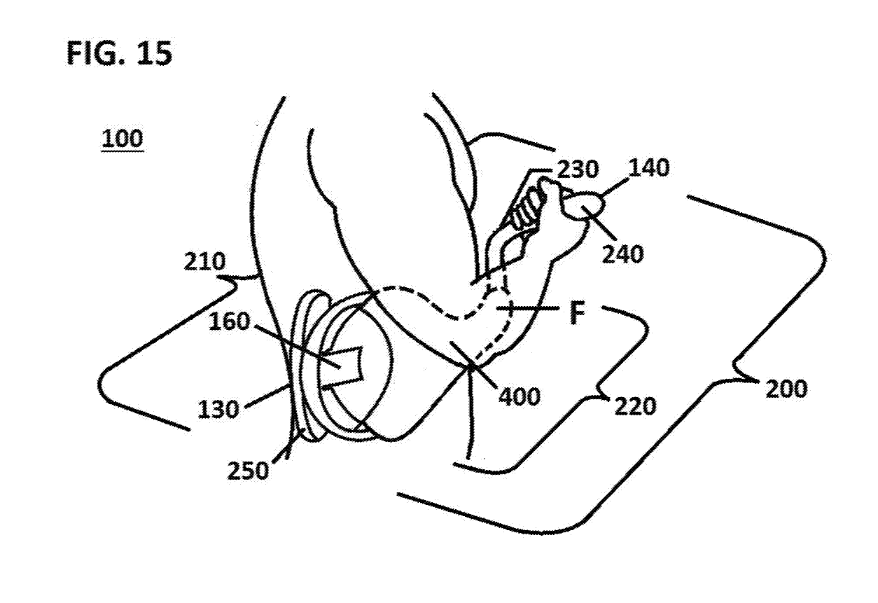

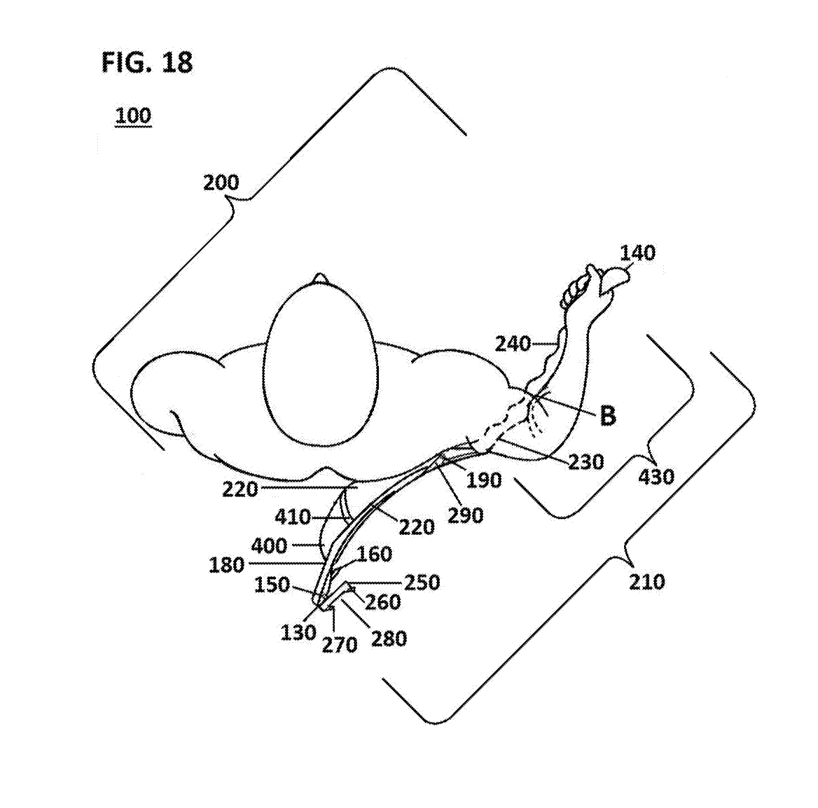

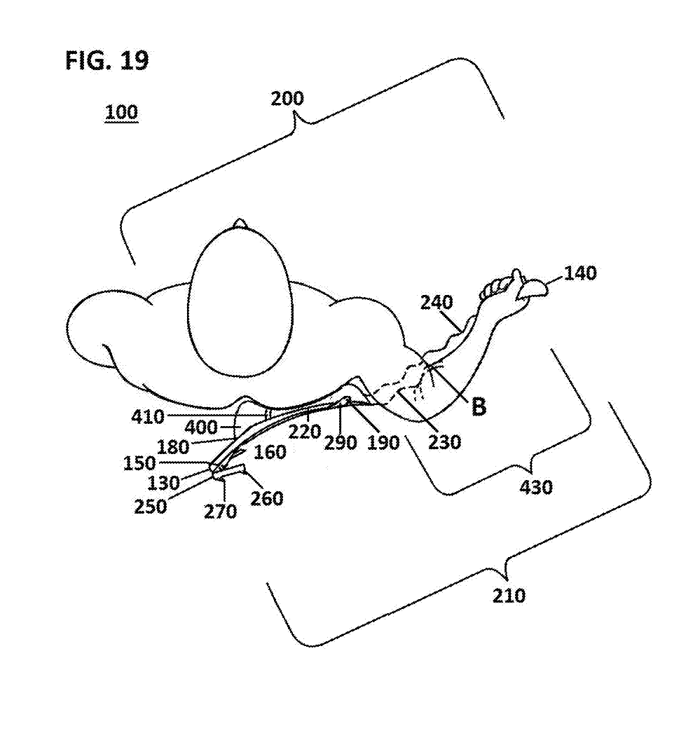

A body leverage surface 220 is located on the outer side 200 of the elongated member 100 near a midway between the grip 230 and the blade end 130 and the blade end 130 configured to press the body leverage surface 220 against a user's forearm when the grip 230 is respectively gripped by fingers and hand by a same arm of the user located on the inner side 210 of the elongated member 100 a thumb of the hand facing away from the blade end 130 of the elongated s-shaped elongated member 100 and the elongated member 100 is reaching the blade end 130 under an armpit of the same arm of the user to leverage the blade attachment 150 located on the inner side 210 of the elongated member 100 against a torso backside of the user. The elongated member 100 does not always need to be an s-shaped member 100. This will be further illustrated in the upcoming FIGS. 3-6 and FIGS. 10-19.

An elongated member 100 may have two body leverage surfaces which are referenced as primary body leverage surface 220 and secondary body leverage surface 430. Each of the two body leverage surfaces are the high point of each corresponding parts of the “S” shape of handle. A primary body leverage surface 220 is illustrated here in the first embodiment in FIG. 1 inside of a blade end 130 and a grip 230 while a secondary body leverage surface 430 is located inside of a grip end 140 and the start of grip 230.

A primary grip 230 comprises a finger surface located on the inner side 210 of the elongated member and grip 240 comprises a finger surface located on the outer side 200 of the elongated member. A grip 230 or 240 is closer in proximity to a grip end 140 of an elongated member 100. A primary grip 230 or a secondary grip 240 is offset beneath a tangent line extending from a central portion of the convex surface contour of the elongated sponge 400 in a direction such that a hand of a user on the grip 230 or 240 does not impinge when extending the elongated sponge 400 onto a torso backside of the user. The finger surface of the grip 230 on the inner side 210 of the elongated member as well as the finger surface of the grip 240 may comprise finger depressions. In FIG. 1 it can be seen that grip 230 has grooves 560 that run inside and along the grip 230 and inside and outside the depressions. The grooves 560 allow for injection molding to take place in order to provide additional grip and control when a user is holding grip 230.

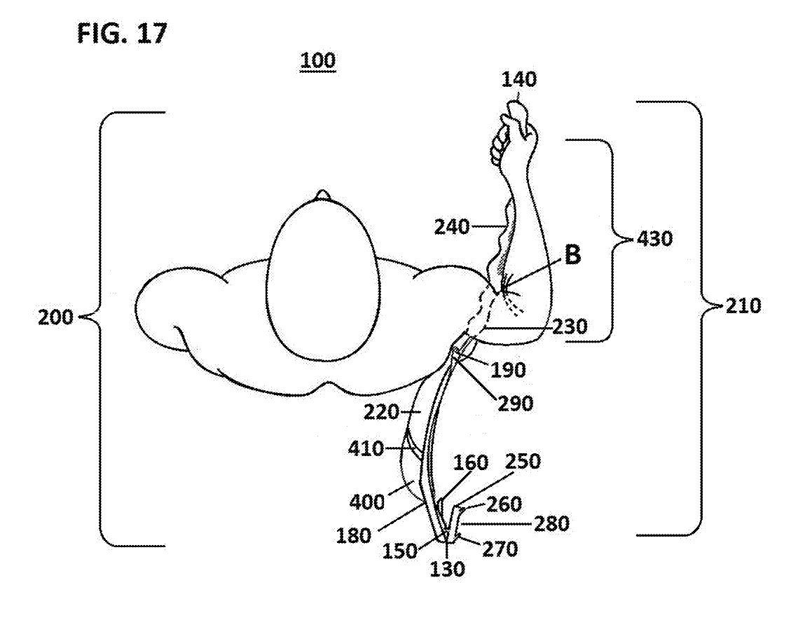

The elongated member presses the elongated sponge 400 against and towards a torso backside of a user when the secondary grip 240 is gripped by fingers and hand of the user which will be illustrated in the upcoming FIGS. 17-22. In one embodiment the elongated sponge 400 may anchor itself only on the outer side 200 of the elongated member. In another embodiment the elongated sponge 400 may wrap itself around an elongated member attaching itself to both the outer side 200 and inner side 210 of the two-side back shaver handle 100 as presented in FIG. 1. In another embodiment there may be more than one anchor. Illustrated in FIG. 1 illustrates at least three anchors. It can be seen a folding anchor 180 which is allowing the elongated sponge 400 located on the outer side 200 to fold through a hole in the elongated member 100 to the inner side 210 of the elongated member 100. Also illustrated are the hook anchor 170 and the snap button 190 all represent anchor points. Anchors may be positioned in closer proximity or further away in proximity to the blade end 130. Folding anchor 180 serves a purpose of holding the end of the elongated sponge 400 closest to the blade end 130. In another embodiment the elongated sponge 400 may anchor itself only on the outer side 200 of the elongated member 100. In another embodiment the hook anchor 170, folding anchor 180 and strap 290 may be may be positioned in closer proximity or further away in proximity to the blade end 130. The pocket 410 is illustrated in FIG. 1 and embodied on said elongated sponge 400 in order to allow a user the option to harness a solid bar of soap inside of said elongated sponge 400 in order to create a lather when applying water and stroking the elongated sponge 400 against the backside.

Letter designations in the drawings depict certain planes, gap distances and contours, defined throughout, and for convenience are summarily defined wherein:
“A” references a flat skin plane;
“H” references a midpoint portion of a non-flexing sharp blade 110; and
“Y” references the angle between the skin surface flat plane A in relation to the midpoint H.

FIG. 2 illustrates a perspective end view looking from an handle end of a two-sided back shaver handle with a sponge and a safety razor configured according to embodiments of the present inventions. In FIG. 2 the rear view of the back shaver handle the elongated member 100 has a surface along a length of the elongated member 100 defining a left side 440 and a right side 450 a blade end 130 and a grip end 140 and the left side 440 opposite the right side 450 and the grip end 140 and blade end 130 between the left side 440 and right side 450. The safety razor 250 is not included when referencing a left side 440 and a right side 450 of the elongated member 100. An elongated member 100 having a surface along a length of the elongated member 100 defining an inner side 210 and an outer side 200 a blade end 130 and a grip end 140 and said outer side 200 opposite the said inner side 210, and having a finger surface grip 230 located on the inner side 210 of the elongated member 100 and a secondary grip 240 located on the outer side 200 of the elongated member 100 and wherein the inner side 210, the outer side 200, the blade end 130, and the grip end 140 join one another to create an outside surface of the elongated member 100. The safety razor 250 located at the blade end 130. In a preferred embodiment the elongated sponge 400 has a uniform thickness. Although it is preferred to have a uniform thickness, other levels of thickness will work. The blade attachment 150 is a portion of the elongated member 100 near the blade end 130 that attaches to an attachment on the safety razor 250. In order for the blade attachment 150 to properly function there is also an attachment on the safety razor 250 for the elongated member 100 to attach itself to. The blade attachment 150 and a attaching piece on the safety razor may take many different forms to allow both safety razor 250 and elongated member 100 to removably attach with one another.

The elongated sponge 400 located in a direction along a length of the elongated member on the outer side 200, wherein the elongated sponge 400 extends longer in a length between the grip 230 or 240 and the blade end 130 than a width between the left side 440 and the right side 450.

FIG. 3 illustrates an aerial view of an elongated member gripped by a user extended under the armpit towards the backside according to embodiments of the present inventions. A blade attachment 150 attaches to a safety razor 250 with a blade group 260 secondary blade group 270 on the inner side 210 of the elongated member facing against the torso backside of the user. The handle has an elongated member 100 having a surface along a length of the elongated member defining an inner side 210 and an outer side 200 a blade end 130 and a grip end 140 and the outer side 200 opposite the inner side 210 and inner side 210 and having a finger surface grip 230 located on the inner side 210 of the elongated member 100 and a secondary finger surface grip 240 located on the outer side 200 of the elongated member 100 and wherein the inner side 210, the outer side 200, the blade end 130, and the grip end 140 join one another to create an outside surface of the elongated member that is substantially smooth and a cross-sectional shape of the elongated member near the midway is substantially smooth having a shape that is substantially round or oval.

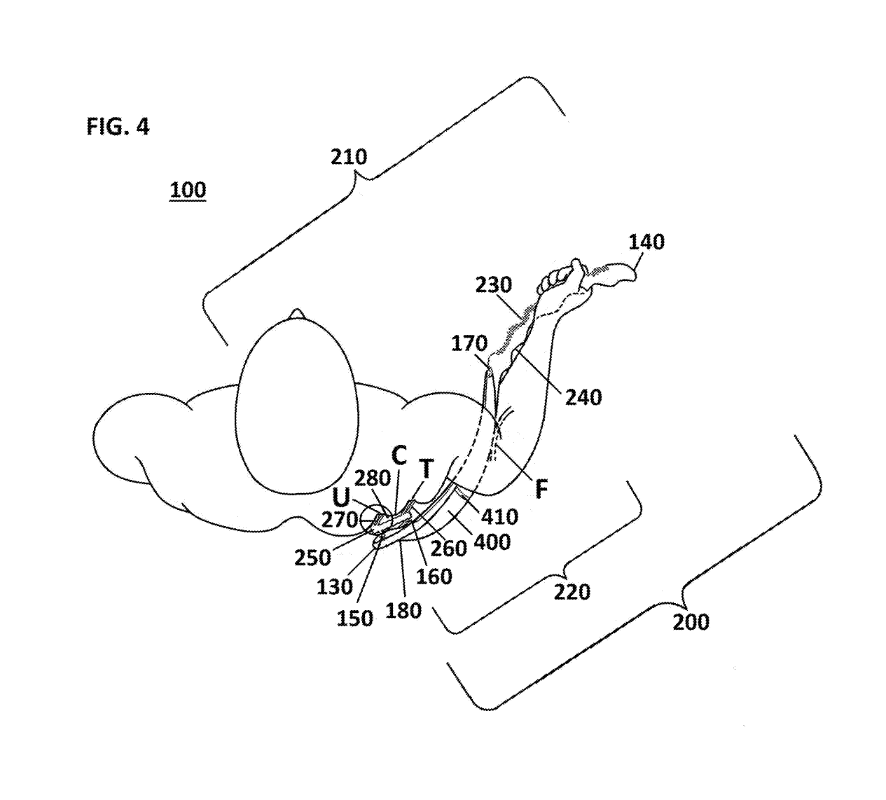

A blade attachment 150 at a blade end 130 of the elongated member 100, the blade end 130 located at an end of the elongated member 100 opposite the grip end 140, the blade attachment 150 located on the inner side 210 of the elongated member 100 and blade attachment 150 comprises a handle clip 160 used to lock and release a safety razor 250 in the blade attachment 150. The blade attachment 150 attaches to the safety razor 250 with at least one blade group 260 protruding away from the safety razor 250 on the inner side 210 of the elongated member facing against the torso backside of the user. This is in order to carry out two-point discrimination, which will be further illustrated and discussed in the upcoming FIGS. 3-8. Both the third embodiment illustrated in FIG. 3 and the fourth embodiment in FIG. 4 illustrates a safety razor 250 having a primary blade group 260 and secondary blade group 270. The safety razor 250 having a plurality of blade groups at an angle from the said safety razor 250 and said safety razor 250 capable of stimulating the mechanoreceptors as well as promoting two-point discrimination when at least two blade groups are present. The blade attachment 150 is a portion of the elongated member 100 near the blade end 130 that attaches to an attachment on the safety razor 250. In order for the blade attachment 150 to properly function there is also an attachment on the safety razor 250 for the elongated member 100 to attach itself to. The blade attachment 150 and a attaching piece on the safety razor may take many different forms to allow both safety razor 250 and elongated member 100 to removably attach with one another.

A body leverage surface 220 is located on the outer side 200 of the elongated member near a midway between the grip 230 and the blade end 130 and the blade end 130 configured to press the body leverage surface 220 against a user's forearm when the grip 230 is respectively gripped by fingers and hand by a same arm of the user located on the inner side 210 of the elongated member a thumb of the hand facing away from the blade end 130 of the elongated member 100 and the elongated member is reaching the blade end 130 under an armpit of the same arm of the user to leverage the blade attachment 150 located on the inner side 210 of the elongated member 100 against a torso backside of the user. FIGS. 3-6 illustrate aerial views of an elongated member with a soft cushion or elongated sponge 400 and the elongated member gripped by a user extended under the armpit towards the backside and reaching the blade end 130 under an armpit of the same arm of the user to leverage the blade attachment 150 located on the inner side 210 of the elongated member 100 against a torso backside of the user. The elongated member with the soft cushion or elongated sponge 400 attached to the body leverage surface 220 where the inner side 210 of the elongated member 100 presses against a user's forearm arm and establishing the fulcrum F. The soft cushion or elongated sponge 400 having a folding anchor 180 and a hook anchor 170 which are illustrated in FIGS. 3-6 and may be positioned in closer proximity or further away in proximity to the blade end 130. Also illustrated in FIGS. 3-6 is a pocket 410 embodied on said elongated sponge 400 in order to allow a user the option to harness a solid bar of soap inside of the elongated sponge 400 in order to create a lather when applying water and stroking the elongated sponge 400 against the backside.

As seen in FIG. 3 when the finger surface and grip 230 are respectively gripped by fingers and hand by a same arm of the user the user is illustrated pressing the body leverage surface 220 located on the outer side 200 of the elongated member near a midway between the grip 230 and the blade attachment 150 and configured to press the body leverage surface 220 against a user's forearm, in which the fulcrum is referenced as F, in order to leverage the blade attachment 150 located on the inner side 210 of the elongated member against a torso backside of the user and leveraging the elongated member using the body leverage surface 220 as a fulcrum F relative to the grip 230 to press the blade end 130 towards the torso backside of the user and stroking the blade end 130 against the torso backside of the user. A portion of the safety razor 250 inside of blade group 260 and secondary blade group 270 is removed in order to create a distance between a primary blade group 260 secondary blade group 270 illustrated as a sensory gap 280. The sensory gap 280 serves multiple purposes. The first purpose is to allow a user to find an effective cutting angle between blade groups and skin surface with ease. Secondly, the sensory gap 280 separates at least two blade groups and allowing them to stabilize one another and the safety razor 250 when stroking against the skin surface. The sensory gap 280 also creates an effective amount of distance between blade group 260 and blade group 270 in order to allow two-point discrimination which will be further described in the upcoming FIGS. 3-8. The elongated member 100 has a straight length or a length that does not follow the curve of the elongated member 100 but rather that actual distance from the blade end 130 to the grip end 140 which is approximately 330 mm to 457.2 mm. A preferred straight length of the elongated member 100 is approximately 355.6 mm.

The sensory gap 280 also grants space for the skin convex C to enter in order to prevent the skin convex C from pressing against the safety razor 250 and interrupting the shaving process which will be illustrated in the upcoming FIG. 4.

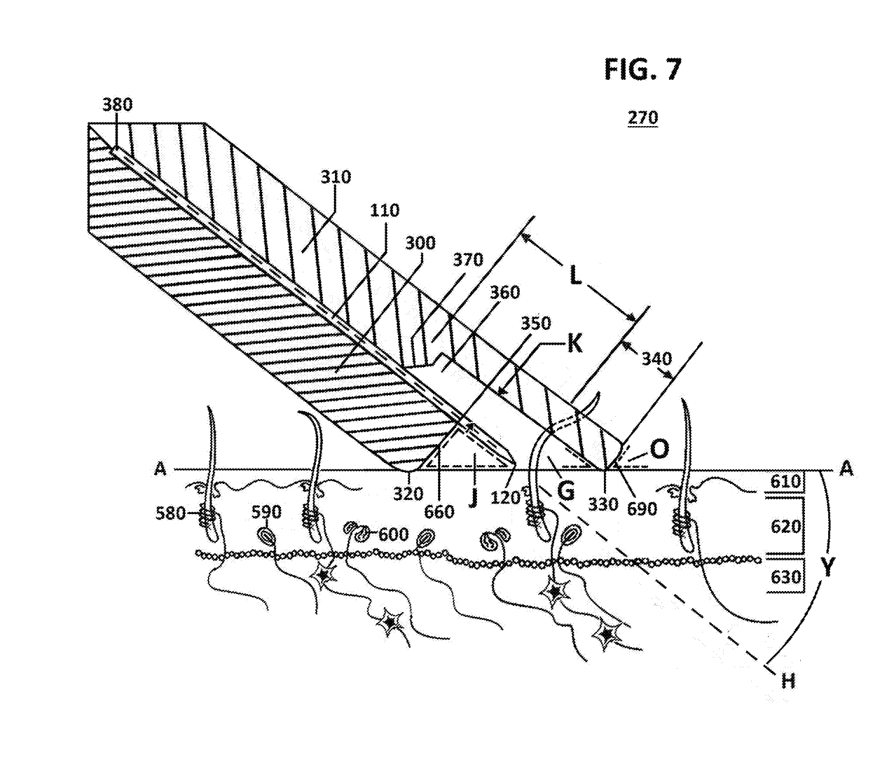

It can be seen in FIG. 3 the blade group 260 is pressing into the skin and is creating an indentation into the skin creating skin convex T inside of the blade group 260. Blade group 260 is creating the first of two points in the two-point discrimination study. In FIG. 3 the blade group 270 is not yet pressing into the skin and the blade group 270 is circled. The circled blade group 270 is FIG. 3 will be further illustrated as a close up view in the upcoming FIG. 7. The two-point discrimination test or the two-point discrimination study offers an understanding on how the components found within the sensory system may be utilized to establish effective communication in utilizing the sensory system without having to actually view the location where the senses are being activated In my invention the two blade groups illustrated by primary blade group 260 and secondary blade group 270 of the safety razor 250 are safety poking the skin surface on the backside or body. The ability to discern between two or more nearby objects touching the skin allows the user to be assured that both blade group 260 and secondary blade group 270 are pressed against skin surface A assuring said blade group 260 and blade group 270 are positioned at the correct cutting angle and ready to shave and allowing the user the knowledge as to where they have shaved and where they still need to shave and that the safety razor 250 is in the correct shaving position. In FIG. 3 the skin convex T is the first of two points safely poking into the skin and stimulating the sensory system. The two-point discrimination study offers an understanding on how the components found within the sensory system may be utilized to establish effective communication through the sensory system without having to actually view the location where the senses are being activated, or in my invention, when the blade group 260 and blade group 270 are safely poking or gouging the skin on the backside or body. The two-point discrimination illustrates the ability to discern that two or more nearby objects gouging or poking the skin are truly multiple distinct points set apart from each other and allowing a user to understand the location of each point. It is often tested with points creating sufficient indents into the skin, as illustrated in my invention, in order to assure the communication is effective. It can be seen in FIG. 3 that the blade group 260 is creating one of the points of the two-point discrimination study wherein in the upcoming FIG. 4 the secondary blade group 270 is creating the second of the two points in the two-point discrimination study which is illustrated as skin convex U.

In research and clinical studies, two-point discrimination is a widely used technique for determining tactile agnosia. According to Sir Sidney Weintein, who tested Weber's observations published in 1835, he finds the theory that there is a lack of uniformity of tactile sensitivity found throughout the body to be correct. In 1960 Sidney Weinstein decided to test the two-point discrimination theory to determine what areas of the body were more sensitive than others. In fact, he concluded the areas of the body such as the face, lips or fingers require less distance between the two points or indents in order to distinguish the two points. During the testing, he found the skin surface located on the back required much more distance between each point in order for the participant to differentiate the two points. However, the exact distance can be influenced based on whether or not the individual the individual has hair on their back. In hairy skin, Merkel nerve endings are clustered into specialized epithelial structures called “touch domes” or “hair disks”. An individual with hair grown in on their backside have additive sensitivity to pressure or skin indentations with the presence of Merkel nerve endings. Merkel nerve endings are found in the basal layer of glabrous and hairy skin and in hairs as well. They provide information on pressure and deep touch which in my invention are provided by blade group 260 and blade group 270.

Furthermore, my invention also adheres to the Atkins-Shiffrin theory. According to the Atkins-Shiffrin theory, memory involves three distinct but related processes: sensory memory, short-term memory and long-term memory. Together, these processes provide the avenue for environmental information to be received by the senses and either put to use, stored for later use or ignored altogether. Most people associate memory processes exclusively with the brain, and for the most part, that is accurate. The sensory memory is responsible for getting the information from the senses to the brain. Our senses are directly linked to our central nervous system, which is comprised of our spinal cord and brain. The process of getting information from our senses to our brain happens very quickly. In fact, it happens so quickly that we are not always consciously aware of everything that is being picked up by our senses.

Sensory memory allows environmental information to be retained, sometimes for as little as a fraction of a second, as it makes its way into our consciousness. Our sensory systems are constantly receiving and processing an incredible amount of information at any given moment. As we go through our day, it is virtually impossible to consciously recognize all of this information. Sensory memory absorbs a tremendous amount of environmental information. It also provides our brains with a lot of details in a short amount of time. Sensory memory allows our brains to make quick reactions and judgments without having to wait on the information to be processed by conscious thoughts. Quite often the information taken in through the senses does end up being consciously processed and used in short-term memory or stored in long-term memory, but thanks to sensory memory, our brains can rapidly sense and perceive a host of environmental information while our brains decide what is useful and what is not.

After stroking the safety razor 250 against the skin during the shaving process a user may have an understanding as to the location of both blade group 260 and blade group 270. Furthermore, it can be said that the sensor memory also allows the user to, for a brief period of time, understand where the safety razor 250 has just been even where the safety razor 250 is no longer present. This means that a user would be able to understand that they have been shaving in one area and may dictate where they need to stop and start based on a communication set forth with sensory memory.

Letter designations in the drawings depict certain planes, gap distances and contours, defined throughout, and for convenience are summarily defined wherein:
“T” references a skin convex inside a blade group 260; and
“F” references a fulcrum between a user's forearm pressing against body leverage surface 220 on the outer side 200 of an elongated member 100 relative to a grip 230 of an elongated handle 100 in order to press the blade attachment 150 near the blade end 130 of an elongated handle 100 towards the torso backside of the user.

FIG. 4 illustrates an aerial view of an elongated member gripped by a user extended under the armpit towards the backside according to embodiments of the present inventions. The blade attachment 150 attaches to a safety razor 250 with at least one primary blade group on the inner side 210 of the elongated member facing against the torso backside of the user. The handle has an elongated member 100 having a surface along a length of the elongated member defining an inner side 210 and an outer side 200 a blade end 130 and a grip end 140 and the said outer side 200 opposite the said inner side 210 and said inner side 210 and having a finger surface grip 230 located on the inner side 210 of the elongated member 100 and a secondary finger surface grip 240 located on the outer side 200 of the elongated member 100 and wherein the inner side 210, the outer side 200, the blade end 130, and the grip end 140 join one another to create an outside surface of the elongated member that is substantially smooth and a cross-sectional shape of the elongated member near the midway is substantially smooth having a shape that is substantially round or oval.

The blade attachment 150 at the blade end 130 of the elongated member 100, the blade end 130 located at an end of the elongated member 100 opposite the grip end 140, the blade attachment 150 located on the inner side 210 of the elongated member 100 and blade attachment 150 comprises a handle clip 160 used to lock and release the safety razor 250 from the blade attachment 150. The blade attachment 150 attaches to a safety razor 250 with a blade group 260 and blade group 270 protruding away from the safety razor 250 on the inner side 210 of the elongated member facing against the torso backside of the user. The safety razor 250 having a plurality of blade groups at an angle from the said safety razor 250 and said safety razor 250 capable of stimulating the mechanoreceptors as well as promoting two-point discrimination when at least two blade groups are present. An elongated sponge 400 is presented in FIG. 4 with a pocket 410 and said elongated sponge 400 is anchored by a hook anchor 170 and a folding anchor 180.

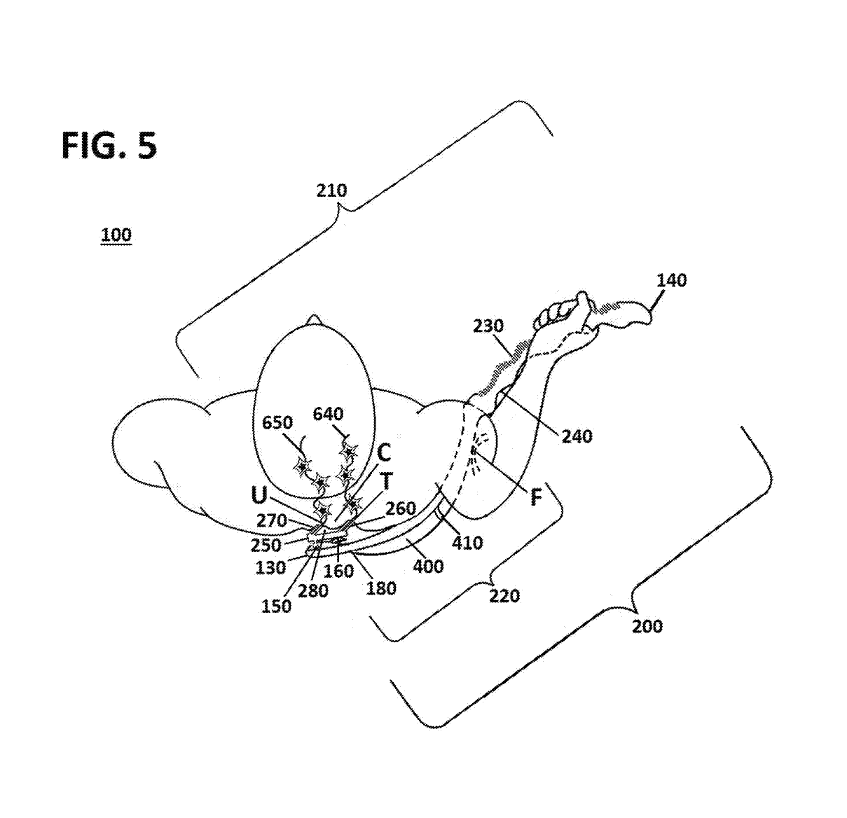

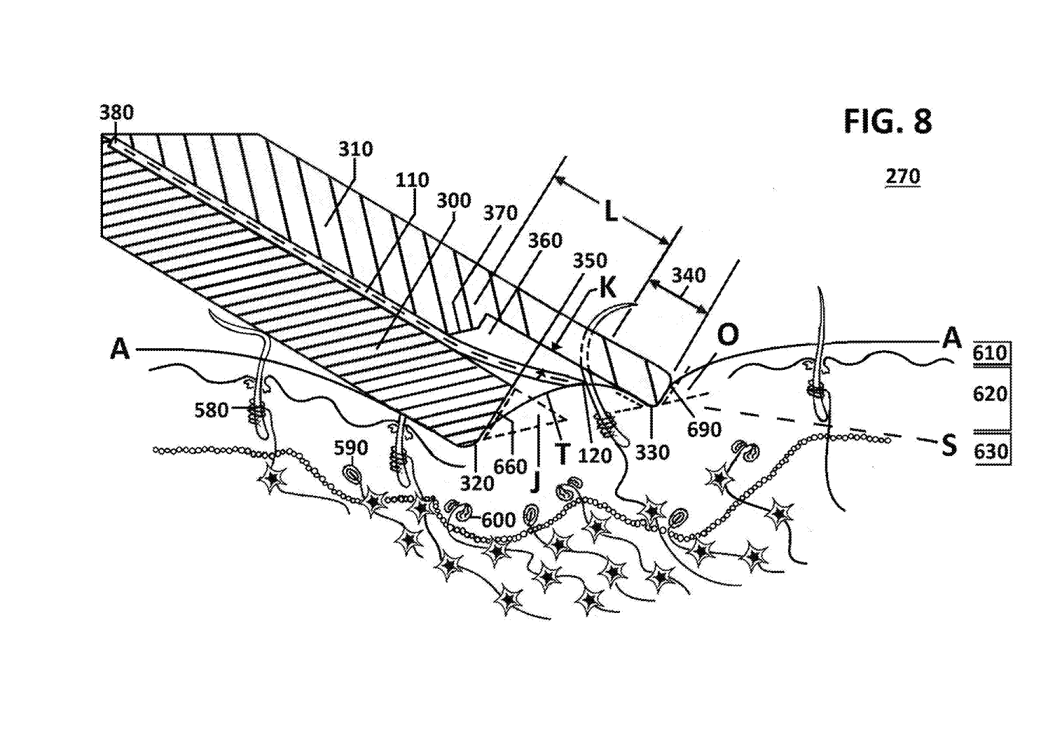

It can be seen in FIG. 4 when the finger surface and grip 230 are respectively gripped by fingers and hand by a same arm of the user the user is illustrated pressing a body leverage surface 220 located on the outer side 200 of the elongated member near a midway between the grip 230 and the blade attachment 150 and configured to press the body leverage surface 220 against a user's forearm, in which the fulcrum is referenced as F, in order to leverage the blade attachment 150 located on the inner side 210 of the elongated member against a torso backside of the user and leveraging the elongated member using the body leverage surface 220 as a fulcrum F relative to the grip 230 to press the blade end 130 towards the torso backside of the user and stroking the blade end 130 against the torso backside of the user. One difference when comparing FIG. 4 to the prior FIG. 3 is that now in FIG. 4 the secondary blade group 270 is now pressing into the skin and with force is creating a skin convex referred to as U along with a blade group 260 which is poking into the skin creating skin convex T. The secondary blade group 270 is creating the second point which is triggering sensors in the human sensory system which will be further illustrated and explained in the upcoming FIGS. 5-8. In FIG. 4 the blade group 270 is circled as the circled area will be further illustrated as a close up view in the upcoming FIG. 8. As illustrated in FIG. 4 the user may now understand the location of both of the two points and the user's sensory system is effectively communicating and allowing the user to know the location of each point as is true within two-point discrimination. Furthermore, in FIG. 4 it can be seen that a skin convex C has formed inside of a sensory gap 280 between the blade group 260 and blade group 270. A portion of the safety razor 250 inside of blade group 260 and secondary blade group 270 is removed in order to create the sensory gap 280. Sensory gap 280 serves multiple purposes. The first purpose is to allow balance and stability of the safety razor 250 when stroking against the skin surface. Sensory gap 280 also grants space for the skin convex C to enter in order to prevent the skin convex C from pressing against the safety razor 250 and interrupting the shaving process. The sensory gap 280 also creates an effective amount of distance between blade group 260 and blade group 270 in order to allow two-point discrimination which will be further illustrated in the upcoming FIGS. 5-8. Skin convex C created inside of the blade group 260 and blade group 270 is a tightening of the skin surface and indicates that the safety razor 250 is indenting properly into the skin surface in order to shave properly and to carry out the two-point discrimination. This form of communication is even further illustrated in the upcoming FIGS. 5-8.

Letter designations in the drawings depict certain planes, gap distances and contours, defined throughout, and for convenience are summarily defined wherein:
“U” references a skin convex inside a blade group 270; and
“C” references a convex skin surface contour engaged inside a blade group 260 and blade group 270.

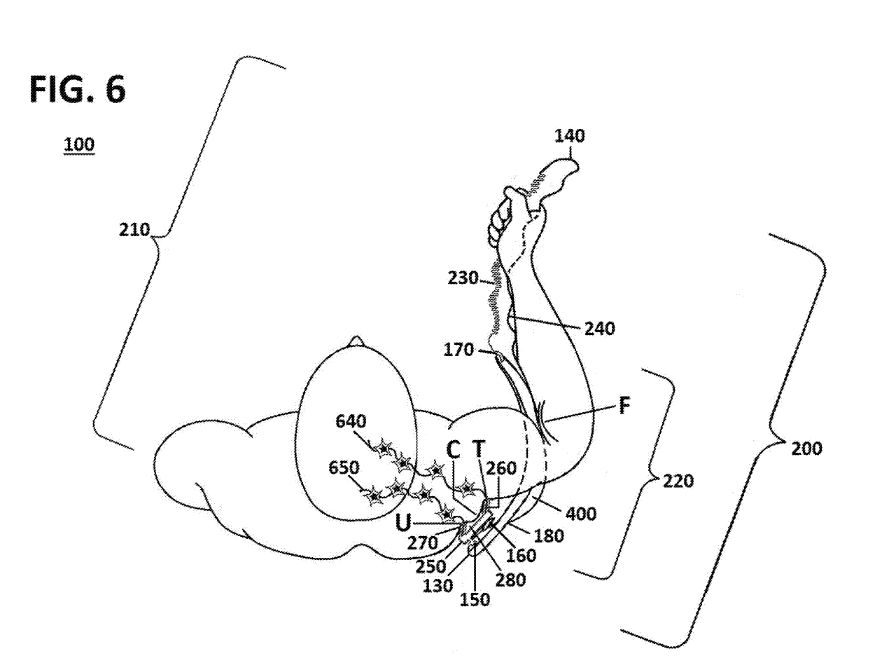

FIGS. 5-6 illustrate aerial views of an elongated member gripped by a user extended under the armpit towards the backside indenting into the skin surface and triggering a sensory system according to embodiments of the present inventions. The elongated member has an elongated member 100 having a surface along a length of the elongated member 100 defining an inner side 210 and an outer side 200 a blade end 130 and a grip end 140 and blade end 130 opposite the grip end 140 and the outer side 200 opposite the inner side 210, and the inner side 210 having a finger surface grip 230 located on the inner side 210 of the elongated member 100 and a secondary finger grip 240 located on the outer side 200 of the elongated member 100 and wherein the inner side 210, the outer side 200, the blade end 130, and the grip end 140 join one another to create an outside surface of the elongated member that is substantially smooth and a cross-sectional shape of the elongated member near the midway is substantially smooth having a shape that is substantially round or oval and a blade attachment 150 at a blade end 130 of the elongated member, the blade end 130 located at an end of the elongated member 100 opposite the grip end 140, the blade attachment 150 located on the inner side 210 of the elongated member 100 and blade attachment 150 comprises a handle clip 160 used to lock and release a safety razor 250 in the blade attachment 150. The blade attachment 150 attaches to a safety razor 250 with at least one blade group 260 is at an angle from the safety razor 250 on the inner side 210 of the elongated member 100 facing against the torso backside of the user. It can be seen that in FIGS. 5-6 a blade group 270 is also at an angle from a safety razor 250. In FIGS. 5-6 safety razor 250 having at least two blade groups at an angle from the safety razor 250 capable of stimulating the mechanoreceptors as well as promoting two-point discrimination. In FIGS. 5-6 a blade group 260 and a blade group 270 are now both pressing into the skin surface creating a skin convex C which is forming inside of a sensory gap 280 between blade group 260 and blade group 270. A portion of the safety razor 250 inside of blade group 260 and blade group 270 is removed in order to create the sensory gap 280.

In FIGS. 5-6 the elongated member has a soft cushion or elongated sponge 400 and said elongated member is gripped by a user extended under the armpit towards the backside according to embodiments of the present inventions. The elongated member with a soft cushion or elongated sponge 400 attached to a body leverage surface 220 where the inner side 210 of the elongated member 100 presses against a user's forearm arm and establishing the fulcrum F. A soft cushion or elongated sponge 400 having a folding anchor 180 which may be positioned in closer proximity or further away in proximity to the blade end 130. Also illustrated in FIGS. 5-6 is a pocket 410 embodied on the outer side 200 of the elongated sponge 400 in order to allow a user the option to harness a solid bar of soap inside of the elongated sponge 400 creating a lather when applying water and stroking the elongated sponge 400 against the backside.

Body leverage surface 220 is located on the outer side 200 of the elongated member near a midway between the grip 230 and the blade end 130 and the blade end 130 configured to press the body leverage surface 220 against a user's forearm creating a fulcrum F in relation to the grip 230 when the grip 230 is respectively gripped by fingers and hand by a same arm of the user located on the inner side 210 of the elongated member a thumb of the hand facing away from the blade end 130 of the elongated member 100 and the elongated member 100 is reaching the blade end 130 under an armpit of the same arm of the user to leverage the blade attachment 150 located on the inner side 210 of the elongated member 100 against a torso backside of the user.

As illustrated in FIG. 5-6 when the finger surface and grip 230 are respectively gripped by fingers and hand by a same arm of the user the user is illustrated pressing the body leverage surface 220 located on the outer side 200 of the elongated member near a midway between the grip 230 and the blade end 130 configured to press the body leverage surface 220 against a user's forearm in order to leverage the blade attachment 150 located on the inner side 210 of the elongated member against a torso backside of the user and leveraging the elongated member using the body leverage surface 220 to create a fulcrum F relative to the grip 230 in order to press the blade end 130 towards the torso backside of the user and stroking the blade end 130 against the torso backside of the user. FIGS. 5-6 further illustrate star shaped figures dispatching from skin convex U and skin convex T. These stars represent the sensors of which are being communicated through the sensory system as a result of first sensory 640 and second sensory 650 being created by blade group 260 and secondary blade group 270 indenting into the skin surface and signaling the sensors. In FIGS. 5-6 skin convex T is being created by blade group 260 while skin convex U is being created by blade group 270. The sensory signals are communicating through the sensory system to the user's brain allowing the user to understand that both the first point or the primary blade group 260 as well as the second point or the secondary blade group 270 are both indenting into the skin and allowing the user to understand the location of the safety razor 250 as well as whether or not the blade group 260 and secondary blade group 270 are at the preferred cutting angle. It can be seen that when comparing FIGS. 5 to 6 the safety razor 250 has made a shaving stroke across the back side. During this stroke it can be seen that the sensors represented by the stars and referenced as first sensory 640 and second sensory 650 have moved from one location to another and the user is gaining the understanding of the old and new location of the safety razor 250 because of tactile two-point discrimination. Also, even though in FIG. 6 the safety razor 250 has traveled across the skin surface in comparison to FIG. 5, due to sensory memory, a user may still feel the previously impressions or indentations made by safety razor 250 in FIG. 5 and in FIG. 6 a user may refrain from shaving in areas on the back that have already been shorn.

FIG. 7 illustrates a cross-sectional close-up view of a blade group 270 previously circled in the prior third illustration in FIG. 3 according to embodiments of the present inventions. A blade group 270 comprising at least one sharp blade 110 comprising a sharp edge 120 facing towards a skin surface A comprising an outer comb 310 comprising an inside edge 330, an a Outer comb inside wall 340 which stretches from the inside edge 330 and rearward to the sharp edge 120 of the sharp blade 110 and an inner guard 300 comprising an inner guard outer edge 320, an inner guard inside end 350 and an inner guard inside wall 660 inside an inner guard outer edge 320 and Inner guard inside end 350. Outer comb inside wall 340 is the inside of the outer comb 310 inside edge 330 and rearward up to the sharp edge 120 of a cutting blade. Inner guard inside end 350 is embodied where the inner guard 300 and the sharp blade 110 meet. An inside portion of the outer comb 310 removed in order to create a deep void 360. The sharp blade 110 is fixedly anchored on the sharp blade end 380 opposite the sharp edge 120. A base 370 is positioned to create a level of distance between the base 370 and sharp edge 120 of the sharp blade 110 in order to enable a controlled level of flexibility with said sharp blade 110. The deep void 360 is spaced intermediately of outer comb 310 and sharp blade 110. The deep void 360 thickness allowing a level of control over the flexibility of a sharp blade 110 as well as over-exposure of the sharp blade 110. Deep void 360 having a thickness which is represented as K. A preferred deep void thickness K of approximately 0.014 inches (0.03556 centimeter) or less is preferred in order to control flexibility of sharp blade 110. Deep void thickness K may run thicker but the danger of enabling the sharp blade 110 to become like a dagger in relation to the skin surface becomes increasingly probable. The level of distance of the deep void 360 between the base 370 and the sharp edge 120 of the sharp blade 110 is referenced as L. In a preferred embodiment in this invention the distance of L is approximately between 0.04-0.14 (0.1016-0.3556 centimeter). L may be less or greater than the preferred distance. However, if the distance of L becomes much greater than 0.04″ inches (0.1016 centimeter) then the sharp blade 110 may start to bend too much and the sharp edge 120 of the sharp blade 110 will run the danger of not cutting effectively. The outer comb 310 Outer comb inside wall 340 creates a barrier for a skin surface convex to enter inside of the inside edge 330 and the inner guard outer edge 320 which will be illustrated in the upcoming FIG. 8. A midpoint of a non-flexing portion of the sharp blade 110 is referred to as midpoint H. In FIG. 7 the inner guard 300 and outer comb 310 are not indenting into the skin surface A and thus the sharp blade 110 is not pressing against the skin surface A and the sharp blade 110 is not flexing and thus the midpoint H is illustrated with a dashed line that is straight and linear. In the upcoming FIG. 8 it will be seen that the sharp blade 110 has changed and the sharp edge 120 of the sharp blade 110 is flexing and is angled in an alternate direction in comparison to midpoint H.

As seen in FIG. 7 a portion inside the inner guard outer edge 320 of inner guard 300 and is removed in order to create a trailing opening J inside of inner guard outer edge 320 and the sharp blade 110 or the sharp edge 120 of the sharp blade 110. In FIG. 7 the trailing opening J is illustrated as a dashed triangle inside of the inner guard outer edge 320 of an inner guard 300 and the sharp blade 110. A trailing opening J cross sectional has three triangular corners or vertices which have three walls but it is not a perfect triangle being that the three walls or sides of the vertices are not always flat. This is especially true of the sharp blade 110 and the skin surface A which both flex under pressure. The inner guard having an inner guard inside wall 660 which is inside an inner guard outer edge 320 and the Inner guard inside end 350 of the inner guard 300. The outer comb 310 is also illustrated having an outer wall 690 which is outside of the inside edge 330. Although in FIG. 7 the inner guard inside wall 660 seem to be perpendicular to the sharp blade 110, the inner guard inside wall 660 may take alternative shapes. For example, in another embodiment the inner guard inside wall 660 may be rounded or curved. This is also true for the outer wall 690 of the outer comb 310 which instead of being somewhat perpendicular to the sharp blade 110 the outer wall 690 may take difference shapes as well such as being rounded or curved or taking another shape. The sharp blade 110, which forms one of the walls or sides will flex and bend. The inner guard inside wall 660 creates a second wall or side. The skin surface A is the third and final wall or side which also deforms and will convex. The skin surface A deforms inside the trailing opening J and tightens itself in order for a sharp blade 110 to access the base of a hair 580 which results in a shave that leaves a smooth skin surface after a shaving stroke. In FIG. 7 there are three vertices take form inside of the trailing opening J. The first of the vertices is where the inner guard inside end 350 and the sharp blade 110 meet. The second of the vertices is where the sharp blade 110 and the skin surface plane A intersect. This second vertices may also be where the sharp edge 120 of the sharp blade 110 and the skin surface plane A meet. The third of the vertices is where the skin surface A and the inner guard outer edge 320 of the inner guard 300 meet. The vertices work to together to form the planes that create the trailing opening J or void which the said trailing opening J allowing for a sufficient opening or void for tightening skin to enter and convex which will be further illustrated in the upcoming FIG. 8 where the skin convex is illustrated. It should also be known that the inner guard inside wall 660 controls the amount of skin convex allowed inside as does the comb 310 Outer comb inside wall 340. In FIG. 7 trailing opening J allowing for a sufficient void or space for tightening skin to enter and convex in order for the sharp edge 120 of the sharp blade 110 to gain access to a base of a hair 580. In FIG. 7 blade group 260 is not yet pressing into the skin surface A and thus the sharp blade 110 is illustrated in a stationary position. It can be seen that the sensors that require pressure in order to trigger such as the Pacinian Corpuscle 590 and the Ruffini's Corpuscle 600 are not yet being triggered since there is only light touch between the blade group 270 and the skin surface A. Only the hairs 580 may detect the light touch. It can be seen in the illustration the tissue sub layers and the sensors within each layer which include the Epidermis 610, the Dermis 620 and the Hypodermis 630.

As seen in FIG. 7 each of the outer teeth 310 is substantially perpendicular to the sharp edge 120 and is spaced with a leading opening G between the row of the outer teeth 310 and the sharp edge 120 of the sharp blade 110. A leading opening G cross sectional has a vertex between the inside edge 330 and the skin plane A which is illustrated with a dashed line. Finally, the outer wall 690 of the outer comb 310 has a vertex of an imaginary triangle between the inside edge 330 and the skin plane A which is illustrated with a dashed line. A void inside this vertex is referred to as void O. Void O allows the blade group 270 to poke or indent into the skin safely.

Letter designations in the drawings depict certain planes, gap distances and contours, defined throughout, and for convenience are summarily defined wherein:
“O” references a void where a vertex is inside of the outer wall 690 of outer comb 310 and a flat skin surface plane A;
“L” references the length of a deep void 360 running lengthwise from the inside edge 330 of outer teeth 310 to the base 370 which allows ample space for the preferred flexibility of a sharp blade 110 to comb 310 inside. The distance of L is approximately between 0.04-0.14 (0.1016-0.3556 centimeter);
“K” references the thickness of the said deep void 360 between the outer comb 310 of the sharp blade 110 which is a contributing factor in the amount of allowed inverted skin convex C as well as the level of flexibility the sharp blade 110 illustrates against inverted skin convex C when shaving. The preferred deep void thickness K of approximately 0.014 inches (0.03556 centimeter) or less;
“J” references a trailing opening inside a sharp blade 110 or sharp edge 120 of a sharp blade 110 and an inner guard outer edge 320 of inner guard 300; and
“G” references a leading opening inside a sharp edge 120 and an inside edge 330 of a comb 310.

FIG. 8 illustrates a cross-sectional close-up view of a blade group 270 previously circled in the prior fourth illustration in FIG. 4 according to embodiments of the present inventions. The blade group 270 comprising at least one flexible sharp blade 110 comprising a sharp edge 120 facing towards a skin surface A and the blade group 270 comprising an outer comb 310 having an inside edge 330, an outer comb inside wall 340 and an inner guard 300 comprising an inner guard outer edge 320 and an inner guard inside end 350. Inner guard inside end 350 is embodied where the inner guard 300 and the sharp blade 110 meet. An inside portion of the outer comb 310 removed in order to create a deep void 360. The sharp blade 110 is fixedly anchored on the sharp blade end 380 opposite the sharp edge 120. Deep void 360 thickness allowing a level of control over the flexibility of the sharp blade 110 as well as over-exposure of the sharp blade 110. The outer comb 310 outer comb inside wall 340 and the inner guard 300 inner guard inside wall 660 both create barriers for the skin surface convex T. Furthermore, an outer comb 310 outer wall 690 allows the inside edge 330 to safely indent to the skin surface A. The deep void 360 is spaced intermediately of outer comb 310 and sharp blade 110. Deep void 360 having a thickness which is represented as K. A preferred thickness K is 0.014 inches (0.03556 centimeter) or less in order to control over exposure of sharp edge 120 of the sharp blade to the skin surface A. Deep void thickness K may run thicker but the danger of cutting becomes increasingly probable. The level of distance of the deep void 360 between the base 370 and the sharp edge 120 of the sharp blade 110 is referenced as L. In a preferred embodiment in this invention the distance of L is approximately between 0.04-0.14 (0.1016-0.3556 centimeter). Although L may be less or greater than the preferred distance if the distance becomes much less than 0.04″ inches (0.1016 centimeter) then the sharp blade 110 becomes more rigid and less able to bend and the sharp blade 110 may become more of a dagger which can be dangerous. If the distance of L becomes much greater than 0.04″ inches (0.1016 centimeter) then the sharp blade 110 will start to bend too much and the sharp edge 120 of a sharp blade 110 will run the danger of not cutting effectively.

In FIG. 8 the blade group 270 pressing into skin surface A according to embodiments of the present inventions. The blade group 270 is safely poking or indenting into the skin surface A in order for the blade group 270 to dry shave hairs properly as well as to create tactile feedback within the practice of two-point discrimination. The blade group 270 comprises a sharp edge 120 of at least one flexible sharp blade 110 comprising a sharp edge 120 facing against the skin surface A of the user and an outer comb 310 comprising an inside edge 330, and an inner guard 300 comprising an inner guard outer edge 320. The sharp edge 120 of the flexible sharp blade 110 longitudinally bends relatively more parallel to the skin surface A when the elongated shaver handle 100 presses the inside edge 330 and the inner guard outer edge 320 into the skin surface A during shaving of hair 580. It can be seen front FIG. 8 that there are star shapes coming from the hairs 580, the Pacinian Corpuscle 590 and the Ruffini's Corpuscle 600 indicating that their sensors are now all actively being triggered due to the skin stretching and pressure from the inner guard 300 and the comb 310 into the skin surface A and forming a tightening skin convex T in order to exposure the base of a hair.

A blade group 270 pressing the inside edge 330 and the inner guard outer edge 320 into the skin surface A during shaving of hair and comprising at least one flexible sharp blade 110 comprising a sharp edge 120 facing against a skin surface A comprising an outer comb 310 comprising an inside edge 330, an outer comb outside Outer comb inside wall 340 and an inner guard 300 comprising an inner guard outer edge 320 and an inside portion of the outer comb 310 removed in order to create a deep void 360. A base 370 is at a distance from the sharp edge 120 of the sharp blade 110. The greater the distance the base 370 is from the sharp edge 120 the more flexible the sharp blade 110 which means a more parallel angle between the sharp blade 110 and the skin surface A. Deep void 360 thickness allows a level of control over the flexibility of the sharp blade 110 as well as over-exposure of the sharp blade 110. As the blade group 260 is pressing into the skin surface A the flexible sharp blade 110 is longitudinally bending relatively more parallel to a skin surface creating a much less aggressive cutting angle between sharp blade 110 and skin surface A. As seen in FIG. 8 the blade group 270 comprising at least one flexible sharp blade 110 comprising a sharp edge 120 facing against the torso backside of the user, and then outer comb 310 comprising inside edge 330 and inner guard 300 comprising the inner guard outer edge 320. It can be seen now in FIG. 8 a trailing opening J pays a role in that it is allowing for a sufficient opening or void for tightening skin convex T and the skin convex T entering between inner guard outer edge 320 and comb inside edge 330. The trailing opening J is illustrated as a dashed imaginary triangle inside of the inner guard outer edge 320 of an inner guard 300 and the sharp edge 120. In FIG. 8 an inner guard inside wall 660 inside of the inner guard outer edge 320 and Inner guard inside end 350 is one of three sides or walls of the imaginary dashed triangle illustrated. The second side is the sharp blade 110 exposure which starts from the inner guard inside end 350 and along the sharp blade 110 up to the sharp edge 120 of the sharp blade 110. The third and final side starts from the sharp edge 120 of a sharp blade 110 and runs along the skin surface plane A when adjacent to a skin surface plane A area and to the inner guard outer edge 320. These three sides from work to together to form a trailing opening J which plays a role in that said void allowing for a sufficient void or space for tightening skin to enter and convex and exposure the base or root of a hair 580 in order to for the sharp blade 110 to cut a hair very effectively which is illustrated here in FIG. 8. Furthermore, the inner guard outer edge 320 and inside edge 330 simultaneously dig into the skin surface A in order to tighten the skin so that when the hair is presented to the sharp blade 110 the root or base is being greatly exposed. The trailing hairs illustrated in FIG. 8 are not shorn because the blade group 270 is merely pressing into the skin surface A. If the blade group 270 were moving forward making a shaving stroke the hairs will become shorn. As seen in FIG. 8 the skin convex T has filled inside the blade group 270 and inside of where the opening G was illustrated in the prior FIG. 7 spaced between the row of teeth 310 and the sharp edge 120. The sharp edge 120 of the sharp blade 110 is flexing against the skin convex T and a midpoint portion of a flexing sharp edge 120 is referenced as midpoint S. Midpoint S is at an angle in relation to the surface of skin convex T which is approximately 35 degrees or less.

It can be seen in the illustration the tissue sub layers and the sensors within each layer which include the Epidermis 610, the Dermis 620 and the Hypodermis 630. For the sake of clarity the sensors located in the deep tissue sub layers are illustrated as being activated from the poke. The star shape embodied on the strand of the sensor indicates the communication taking place. The illustrated sensors include the Ruffini's Corpuscle 600, which are found in the Dermis 620 and the Pacinian Corpuscle 590, which are found in the “subcutaneous” or hypodermis 630. As previously illustrated in FIGS. 5-6 and as illustrated here in FIGS. 7-8 the star shapes represent sensors being triggered in the sensory system.

Letter designations in the drawings depict certain planes, gap distances and contours, defined throughout, and for convenience are summarily defined wherein:
“S” references a midpoint portion of a flexing sharp blade.

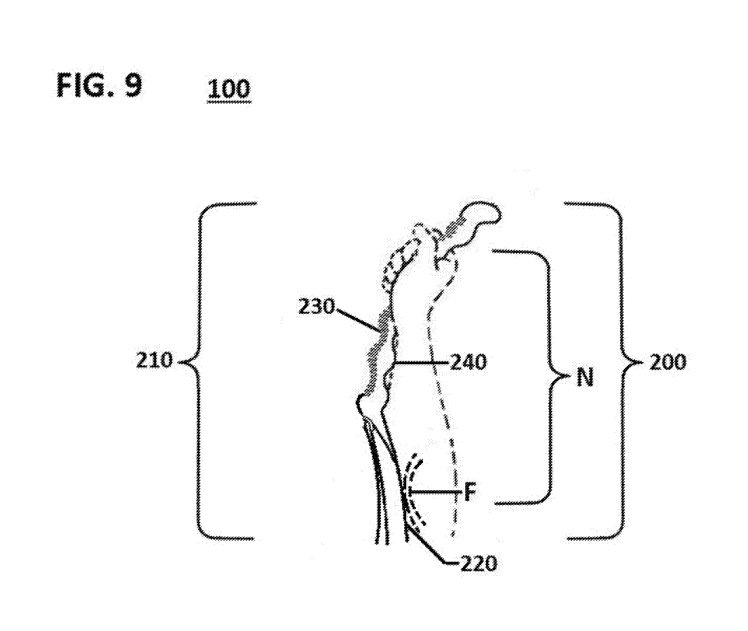

FIG. 9 illustrates a top view of a wrist area of an elongated member 100 for a user according to embodiments of the present inventions. The body leverage surface 220 is illustrated in FIG. 9 is pressing into the forearm creating a fulcrum which is referenced as F and an outer side 200 and an inner side 210 of the elongated member 100 are illustrated wherein the outer side 200 is opposite the inner side 210 and the outer side 200 is against a user's forearm. The fulcrum F is created when the forearm is pressing against the body leverage surface 220 in order to press the elongated member 100 into the back side while the elongated member 100 is able to be held firmly in a neutral wrist position during the method of shaving the lower half of the back. As can be seen in FIG. 9 the wrist is positioned and locked into what is known as a neutral resting position. Inside of the grip end 140 where a user's hand gripping the grip 230 in relation to a fulcrum F is a margin referenced as neutral wrist margin N. Neutral wrist margin N represents the margin inside of fulcrum F and inside a grip end 140 where a user is gripping grip 230 and a secondary grip 240 is against a user's forearm and altogether allowing a user's wrist to be in a temporarily locked and neutral position and not bending or stressing during a shaving stroke. Most handles on the market used to shave one's back do not effectively add the leverage nor do they maintain support needed between the forearm, wrist and handle that would prevent wrist and shoulder problems. It is often commonly found within most prior art we see the wrist taking most if not all of the stress necessarily exerted in order to brace and navigate the handle in the many different angles and positions necessary to properly shave one's own back side. Within the prior art a user often experiences wrist “Flexion” and wrist “Extension”. Wrist flexion is when the palm bends towards the forearm while wrist extension is when the palm moves away from the forearm resulting in a decrease of angle. When the wrist is granted access to the several motions that permit overuse we also find another motion of stress which is referred to as “Pronation” and “Supination” of the wrist. Pronation and supination are a pair of unique movements within the forearms and hands, allowing the human body to flip the palm either face up or face down. The muscles, bones, and joints of the human forearm are specifically arranged to permit these unique rotations of the hands. Supination of the forearm occurs when the forearm or palm are rotated outwards. Pronation at the forearm is a rotational movement where the hand and upper arm are turned inwards. Yet another range of motion within the wrist that adds a level of stress is known as “Radial Deviation” and “Ulnar Deviation.” Radial and Ulnar Deviation are a pair of movements tilting the wrist from one side to the other. Radial deviation is to move the thumb side of the hand down towards the wrist and ulna deviation is moving the little finger side down. These movements create added stress and may be very difficult for a user who suffers from a wrist syndrome such as Carpal Tunnel Syndrome (CTS) and may often lead to other joint or muscle related issues. Carpal Tunnel Syndrome (CTS) can be associated with any condition that causes pressure on the median nerve at the wrist. Another limiting wrist syndrome is known as Wrist Osteoarthritis which can result is a group of mechanical abnormalities which can result in joint destruction. These abnormalities include degeneration of cartilage and hypertrophic bone changes, which can lead to extreme pain, swelling and loss of function. Another limiting wrist syndrome is known as a Scaphoid Fracture which is a fracture of the scaphoid bone also known as the carpal navicular. This is the most common type of carpal bone fracture. Scaphoid fractures usually cause pain at the base of the thumb accompanied by swelling in the same area. Scaphoid fractures usually cause pain and sensitivity to palpation in the anatomic snuffbox at the base of the thumb accompanied by swelling in the same area. Fractures of scaphoid can occur either with direct axial compression or with hyperextension of the wrist, such as a fall on the palm on an outstretched hand. Circumduction of the Wrist is another common movement used when attempting to reach areas of the back for shaving. Circumduction describes a continuous circular movement of a limb around a joint. Circumduction of the wrist occurs when the wrist joint allows movement of the limb that can scribe a circle in the air. Most muscular movement of the body can be described through the use of circumduction, abduction, adduction, flexion or extension or some combination of the five. The muscles used in circumduction of the wrist are any muscle with origin on the forearm and insertion on phalanges or metacarpals.

The opposite it can be seen in the ninth embodiment in FIG. 9 the forearm is able to secure itself against the body leverage surface 220 in order to lock the wrist into a neutral position preventing the wrist problems discussed herein. Thus, when shaving the lower half of the back from side of torso as well as the top half of the back from over the shoulder both supination and pronation of the forearm is prevented. Since the wrist in the prior art in not allowed to lock itself into a neutral position but rather instead taking on the majority of the stress of balancing the handle as well as the stress of holding the handle at a preferred angle there are areas of stressed placed on the wrist wherein someone who struggles with a wrist problem such as Carpal Tunnel Syndrome (CTS) or perhaps Wrist Osteoarthritis would have a difficult and painful time attempting to use prior handles.

Letter designations in the drawings depict certain planes, gap distances and contours, defined throughout, and for convenience are summarily defined wherein:
“N” references a margin inside of a fulcrum F and a grip end 140 where a user is gripping grip 230.

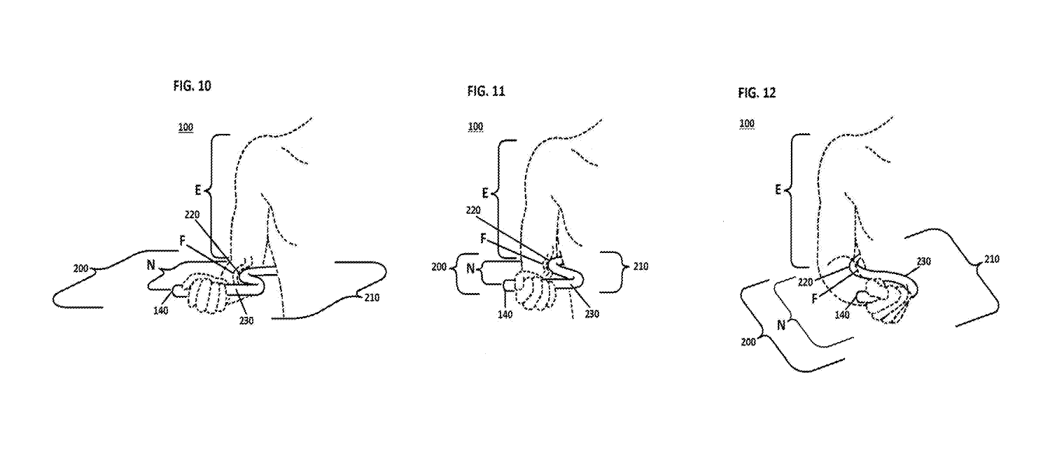

FIGS. 10-12 illustrate front views of user utilizing an elongated member 100 according to embodiments of the present inventions. The elongated member is an elongated member 100 having a surface along a length of the elongated member defining a body leverage surface 220, an inner side 210 and an outer side 200 and a grip end 140 and the outer side 200 opposite the said inner side 210.

The body leverage surface 220 located on the outer side 200 of the elongated member 100 configured to press against a user's forearm when the grip 230 is respectively gripped by fingers and hand by a same arm of the user and the elongated member is reaching the blade end under an armpit of the same arm of the user to leverage the blade attachment which his behind a user in FIGS. 10-12. A user is leveraging the blade attachment located opposite the grip end 140 against a torso backside and leveraging the elongated member using the body leverage surface 220 creating a fulcrum F relative to the grip 230 to press the blade attachment towards the torso backside of the user and stroking the blade attachment against the torso backside of the user. FIG. 10-12 is a front view of the user carrying out a shaving stroke on the lower half of their back side. The elongated handle 100 is allowing the user's arm to remain “adducted” which is represented by E. Adduction E of the arm means “the movement of a limb towards the midline of the axis of the body” as defined by Mosby's Medical Dictionary, 8th edition, 2009, Elsevier. Adduction is a movement towards the mid-line of the body. This also applies to movements inwards and across the body. That is, movement of the right arm inwards (so to the left) towards or even past the center of the body would be adduction of the right arm.

Adduction E references the adduction taking place during the shaving stroke. It can be seen that the adduction E allows the shoulder and the elbow to remain at an adducted position towards the medial plane of the body and not extending outward in an abducted manner. The opposite of adduction is abduction. Abduction occurs when the arms are held at the sides, parallel to the length of the torso, and are then raised in the plane of the torso. Abduction plays a role in shoulder problems and can increase the level of pain when an individual is experiencing shoulder impingement syndrome. Impingement syndrome is a common cause of shoulder pain. It occurs when there is impingement of tendons or bursa in the shoulder from bones of the shoulder. Abducting the shoulder by using overhead activity of the shoulder, especially repeated activity, is a risk factor for shoulder impingement syndrome. Other risk factors of shoulder impingement syndrome include bone and joint abnormalities. With impingement syndrome, pain is persistent and affects everyday activities. Motions such as reaching up behind the back or reaching up overhead to shave one's own back can cause pain. Over time impingement syndrome can lead to inflammation of the rotator cuff tendons (tendinitis) and bursa (bursitis). If not treated appropriately, the rotator cuff tendons can start to thin and tear.” The typical symptoms of impingement syndrome include difficulty reaching up behind the back, pain with overhead use of the arm and weakness of shoulder muscles. Shoulder pain is the third most common cause of musculoskeletal consultation in primary care. One percent (1%) of adults with new shoulder pain consult their GP each year. Self-reported prevalence of shoulder pain is between 16% and 26%. Historically, lateral shoulder pain worsens with positions or activities which put stretch on the glenohumeral joint which progresses to stiffness.

Neutral wrist margin N as seen in FIGS. 10-12 and previously discussed and illustrated in the prior FIG. 9, is illustrating when the wrist is capable of resting and interlocking with the elongated member in a neutral position. Combining this factor while at the same allowing a user's arm to remain adducted E together prevents both wrist and arm health problems. The neutral wrist margin N is illustrated in FIG. 10-12 as interlocking with the elongated s-shaped elongated member 100 inside of the grip end 140 and the body leverage 220. The method in which the wrist and shoulder are limited when using the elongated member 100 prevent both health issues describe herein with the wrist as well as with the shoulder. The neutral wrist margin N is created when a user is gripping the grip 230 of the elongated member 100 combined with the body leverage surface 220 located on the outer side 200 of elongated member near a midway between the grip 230 and the blade end 130. The body leverage surface 220 creating fulcrum F and a user gripping grip 230 allows a neutral wrist margin N to exist. Also, the blade end 130 configured to press the body leverage surface 220 against a user's forearm creating fulcrum F when the grip 230 is respectively gripped by fingers and hand by a same arm of the user located on the inner side 210 of the elongated member 100. The blade end 130 is not illustrated in FIGS. 10-12 because the user is blocking the view. However for clarification the blade end 130 was illustrated in the prior FIGS. 1-6.

Letter designations in the drawings depict certain planes, gap distances and contours, defined throughout, and for convenience are summarily defined wherein:
“E” references a margin of adduction of a user's shoulder to elbow wherein the user's arm is able to remain adducted during shaving.

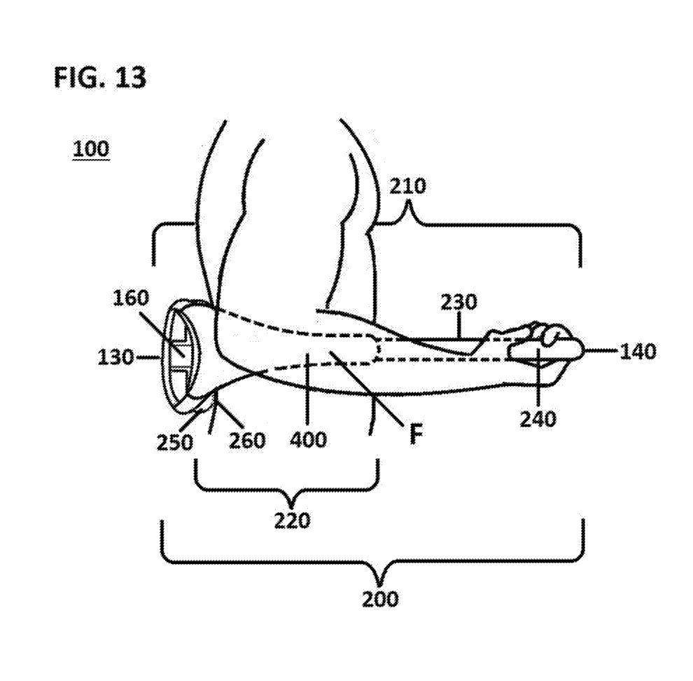

FIGS. 13-15 illustrate side views of a user utilizing an elongated member 100 according to embodiments of the present inventions. The elongated member 100 has a generally elongated member having a surface along a length of the elongated member 100 with a blade end 130 and a grip end 140 and a blade end 130 opposite the grip 230 and the outer side 200 opposite the said inner side 210, and between the outer side 200 and the inner side 210 and the grip 230 located on the inner side 210 and a secondary grip 240 on the outer side 200 opposite the grip 230 of the elongated member 100 which can be seen in FIGS. 13-15. A handle clip 160 used to lock and release a safety razor 250 and at least a blade group 260 protruding away from the safety razor 250.

A body leverage surface 220 is located on the outer side 200 of the elongated member 100 near a midway between the grip 230 and the blade end 130 and the blade end 130 configured with the elongated sponge 400 to press the body leverage surface 220 against a user's forearm creating fulcrum F when the grip 230 is respectively gripped by fingers and hand by a same arm of the user located on the inner side 210 of the elongated member 100 a thumb of the hand facing away from the blade end 130 of the elongated member 100 and the elongated member 100 is reaching the blade end 130 under an armpit of the same arm of the user to leverage the blade attachment and safety razor 250 located on the inner side 210 of the elongated member 100 against a torso backside of the user.

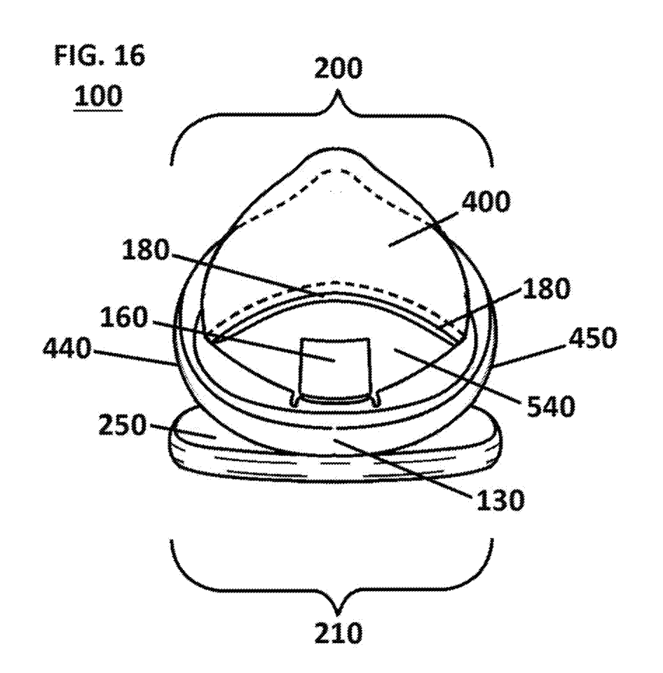

FIG. 16 illustrates a front view of a blade end 130 of an elongated member 100 according to embodiments of the present inventions. The elongated member 100 having an outer side 200, an inner side 210, a left side 440 and a right side 450 wherein the outer side 200 is opposite the inner side 210 and the left side 440 is opposite the right side. A safety razor 250 removably attaching near the blade end 130 to the handle attachment having a handle clip 160. An elongated sponge 400 is located on the outer side 200 of the elongated member closer to the blade end 130. The elongated sponge 400 is wrapping itself over the outer side 200 of the elongated member 100 and through a handle opening 540 near the blade end 130 where a folding anchor 180 securing the elongated sponge 400 in order to continue underneath the elongated member 100 on the inner side 210 of the elongated member 100. That being said, portion of the elongated sponge 400 may be presented on the inner side 210 and the outer side 200 of the elongated handle as well. In a preferred embodiment the elongated sponge 400 has a uniform thickness. Although it is preferred to have a uniform thickness, other levels of thickness will work.

FIGS. 17-19 illustrate aerial views of a user utilizing an elongated member 100 according to embodiments of the present inventions. The elongated member 100 has an elongated member 100 having a surface along a length of the elongated member 100 defining an outer side 200 an inner side 210, a blade end 130, a grip end 140, and a primary body leverage surface 220 located on the outer side 200 of the elongated member 100 configured to press secondary body leverage surface 430 against the inside of a user's forearm creating a fulcrum B. Secondary body leverage surface 430 is on the opposite side of the first body leverage surface 220 and closer to an opposite end. A secondary body leverage surface 430 is located on the inner side 210 of the elongated handle inside of a grip end 140 and a body leverage surface 220. A secondary body leverage surface 430 is utilized to press against a user's forearm in order to press the body leverage surface 220 having an elongated soft sponge cushion 400 against a user's backside as seen in FIGS. 17-19. Illustrated in FIGS. 17-19 the elongated member 100 has been flipped or reversed and a fulcrum B is relative to the grip 240 to press the elongated soft sponge cushion 400 against the torso backside of the user. The elongated member 100 having a flexible elongated sponge 400 with a strap 290 a snap button 190 and a folding anchor 180 and the elongated sponge 400 or soft cushion capable of holding a skin care product. The elongated member 100 elongated soft sponge cushion 400 or cushion is capable of holding a skin care product when the user reverses the fingers and the hand at the grip and so the fingers are located opposite the grip 230 at the secondary grip 240 and the elongated member 100 is reaching the elongated soft sponge cushion 400 or soft cushion against a torso backside of the user while a user's forearm is against the secondary body leverage surface 430 creating fulcrum B. The soft cushion or elongated sponge 400 strap 290 and snap button 190 are for securing the elongated sponge 400 to the elongated handle 100. Furthermore, embodied on the elongated sponge 400 in FIGS. 17-19 is a pocket 410 which may hold lotion or soap.

In FIGS. 17-19 the grip 240 is respectively gripped by fingers and hand by a same arm of the and the elongated member 100 is reaching the blade end 130 under an armpit of the same arm of the user to leverage the elongated sponge 400 of the elongated member 100 against a torso backside of the user. During the shaving stroke of the lower half of the back the present method allows the blade end 130 to reach the center of the spinal area which often has a slope or a valley that often proves difficult to perform a task such as a shaving stroke.

A blade attachment 150 is at a blade end 130 of the elongated member 100, the blade end 130 located at an end of the elongated member 100 opposite the grip end 140 the blade attachment 150 located on the inner side 210 of the elongated member 100 and blade attachment 150 comprises a handle clip 160 used to lock and release a safety razor 250 in the blade attachment 150. The blade attachment 150 attaches to a safety razor 250 and in FIGS. 17-19 a blade group 260 and a secondary blade group 270 protruding away from the safety razor 250 and a sensory gap 280 on the inner side 210 of the elongated member 100 facing away from the torso backside of the user inside of the blade group 260 and the blade group 270. Blade group 260 and secondary blade group 270 at an angle from the said safety razor 250 and capable of stimulating the mechanoreceptors as well as promoting two-point discrimination.

The secondary body leverage surface 430 is located on the inner side 210 of the elongated member 100 near a midway between the grip end 140 and the elongated sponge 400 and is configured to press the secondary body leverage surface 430 against a user's forearm and creating fulcrum B when the grip is respectively gripped by fingers and hand by a same arm of the user located on the inner side 210 of the elongated member 100 a thumb of the hand facing away from the blade end 130 of the elongated member 100 and the elongated member 100 is reaching the blade end 130 under an armpit of the same arm of the user to leverage the elongated sponge 400 located on the outer side 200 of the elongated member 100 against a torso backside of the user.

Letter designations in the drawings depict certain planes, gap distances and contours, defined throughout, and for convenience are summarily defined wherein:
“B” references a secondary fulcrum opposite fulcrum “F” and created when a secondary body leverage surface 430 creating fulcrum B relative to grip 240.

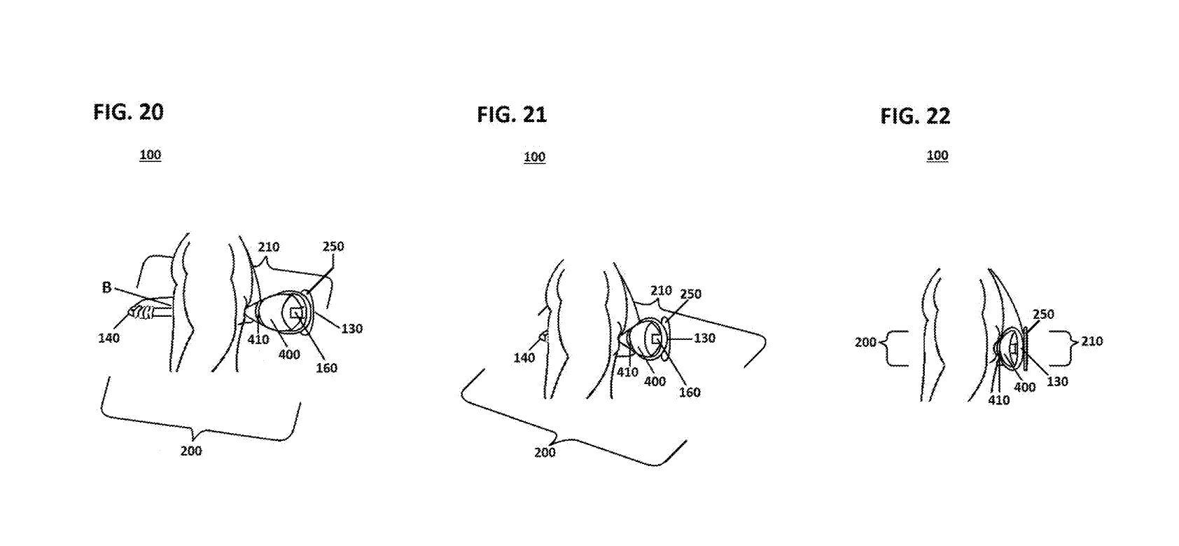

FIGS. 20-22 illustrate side views of an elongated member 100 configured with a soft cushion or elongated sponge 400 a handle clip 160 a safety razor 250 on an opposing side of said sponge or elongated soft sponge cushion 400 and the elongated member 100 gripped by a user extended under the armpit towards the backside according to embodiments of the present inventions. The handle has an elongated member 100 with a soft cushion or elongated sponge 400 attached to a body leverage surface on the outer side 200 and the inner side 210 of an elongated member 100 where the inner side 210 of the elongated member 100 presses against a user's forearm arm and establishing the secondary fulcrum B. It can be seen by FIGS. 20-22 the elongated member 100 is reversed from a positioned as previously illustrated in the previous FIGS. 3-6, 9-15. In the prior FIGS. 3-6, 9-15 the fulcrum F is illustrated relative to the grip 230 to press the blade end 130, opposite the grip end 140, towards the torso backside of the user and stroking the blade end 130 against the torso backside of the user. As illustrated in FIGS. 20-22 the elongated member 100 has been flipped or reversed to press the elongated soft sponge cushion 400 against the torso backside of the user and the fulcrum B is illustrated relative to the grip 240. The elongated member 100 elongated sponge 400 having a plurality of anchors capable of holding a skin care product when the user reverses the fingers and the hand at the grip and so the fingers are located opposite the finger surface grip and the elongated member 100 is reaching the elongated soft sponge cushion 400 against a torso backside of the user. The elongated member 100 elongated soft sponge cushion 400 or cushion near the body leverage surface capable of holding a skin care product when the user reverses the fingers and the hand at the grip and so the fingers are located opposite the finger surface at a secondary grip and the elongated member 100 is reaching the elongated soft sponge cushion 400 or cushion attachment against a torso backside of the user. Said elongated soft sponge cushion 400 or cushion attachment has a pocket 410 for attaching the skin care product to the elongated member near the body leverage surface.

It can be seen in FIGS. 20-22 a user is gripping a hand on a grip of an elongated member 100 having a surface along a length of the elongated member 100 defining an inner side 210 and an outer side 200 a blade end 130 and a grip end 140 wherein the blade end 130 opposite the grip end 140 the outer side 200 opposite the inner side 210 and a blade attachment at a blade end 130 of the elongated member 100, the blade end 130 located at an end of the elongated member 100 opposite the grip end 140, the blade attachment located on the inner side of the elongated member 100 and where gripping fingers of the hand on a finger surface located on the inner side 210 of the elongated member 100. The blade attachment comprises a handle clip 160 used to lock and release a safety razor 250. FIGS. 20-22 illustrates the movement or motion a user makes when utilizing the method in which the inventions described function effectively while preventing the health problems described herein.

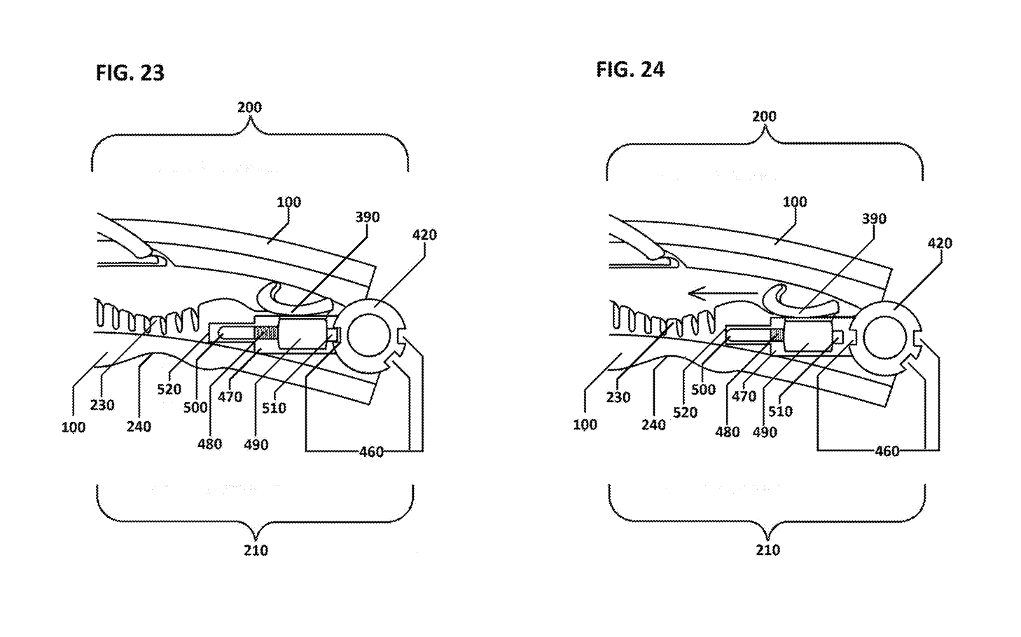

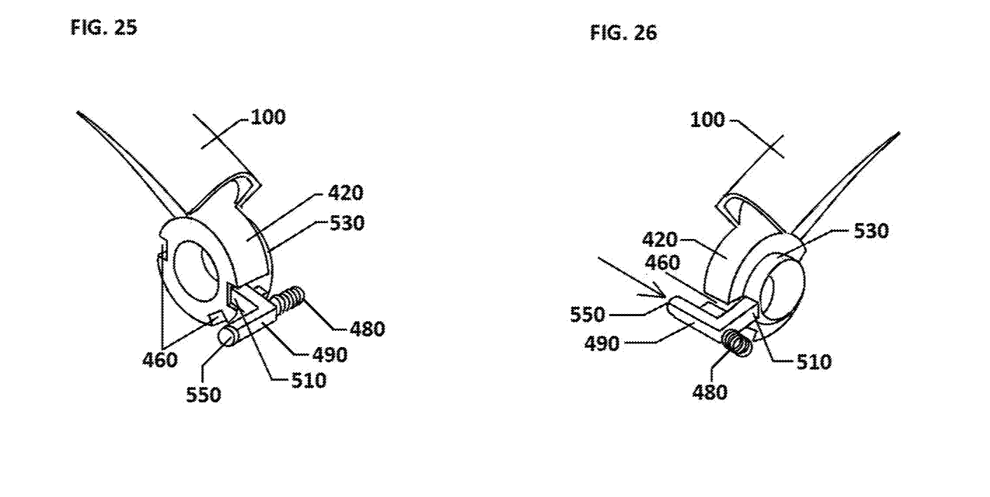

FIGS. 23-24 illustrate a side view of a two-sided back shaver handle with a hinge, a pull trigger and constituent parts of a handle according to embodiments of the present inventions. FIGS. 23-24 illustrate a hinge 420 near the midway of the elongated member and said hinge 420 configured to fold an elongated member 100 having a primary grip 230 and a secondary grip 240. The hinge 420 having several female slots 460 embodied on the perimeter of the hinge 420. The trigger 390 is working together with a hinge 420 to allow the elongated member 100 the fold itself and interlock itself into a preferred angled position. The trigger 390 coupled with a plunger 490 having a peg 510 and an outside end 500 designed to move back and forth inside of a container 470 by method of a flexible spring 480 implemented to allow the back and forth lateral movement. FIG. 23 illustrates the trigger 390 in an uninterrupted position wherein we see the peg 510 of the plunger 490 is inside of a female slot 460 and keeping the elongated member 100 in a temporarily locked position. In FIGS. 23-24 the trigger 390 coupled with the plunger 490 having a peg 510 and an outside end 500 where peg 510 is opposite outside end 500 of plunger 490 and designed to move back and forth inside of the container 470 by method of the flexible spring 480. When the flexible spring 480 is uninterrupted and expanded an outside end 500 of the plunger 490 is further from the container outside end 520 in comparison to when the flexible spring 480 is contracted as illustrated FIG. 24. As seen in FIG. 24 the trigger 390 is pressing with force by a user and moving inside of the container 470 and away from the hinge 420 in order for the peg 510 to remove itself from a female slot 460 of the hinge 420 by compressing the flexible spring 480 and bringing the plunger outside end 500 closer to the container outside end 520. The container outside end 520 is opposite the peg 510 end. In FIG. 24 the user may now unfold the elongated member 100. The hinge 420 moves to fold the elongated member 100 back against itself for storage. A user may activate the finger trigger 390 by pulling or pushing or in some instances the finger trigger 390 is replaced with a push-button which will be illustrated in the upcoming FIGS. 25-26. In FIGS. 23-24 the hinge 420 moves approximately 180 degrees to completely fold the elongated member 100 back against itself for storage and reduce a length of the elongated member 100. In FIGS. 23-24 it can be seen that when an elongated member 100 is folded a secondary grip 240 is on the inner side 210 of said elongated member 100 opposite the outer side 200. There may be one or more female slots 460 on a hinge 420.

FIGS. 25-26 illustrate side views of a two-sided back shaver handle with a hinge, a push button constituent parts of handle according to embodiments of the present inventions. FIG. 25-26 are close up angled views of a hinge 420 wherein a user may push a push button 550 instead of pulling a finger trigger 390 in the previous FIGS. 23-24. With force a user may press the push button 550 by method of a flexible spring 480 in order to move a peg 510 out of the female slot 460 and into a hinge channel 530 allowing the hinge 420 to move uninterrupted by the peg 510 approximately 180 degrees to completely fold the elongated member 100 back against itself for storage and to reduce a length of the elongated member 100. A user may push the push button 550 with a plunger 490 inside of the hinge 420 by method of the spring 480 in order to move the peg 510 out of the female slot 460 and into the hinge channel 530 and allowing the hinge 420 to move approximately 180 degrees to completely fold the elongated member 100 back against itself for storage and to reduce a length of the elongated member 100. When using the push button 550 a user is pushing said push button in a direction towards the left side or right side of the elongated member 100 which was previously illustrated in the prior FIG. 2 and FIG. 16 and when the trigger 390 is embodied a user is pushing or pulling in a direction towards the blade end 130 or grip end 140 of the elongated member 100 which was previously illustrated in the prior FIGS. 1-6 and FIGS. 10-15.

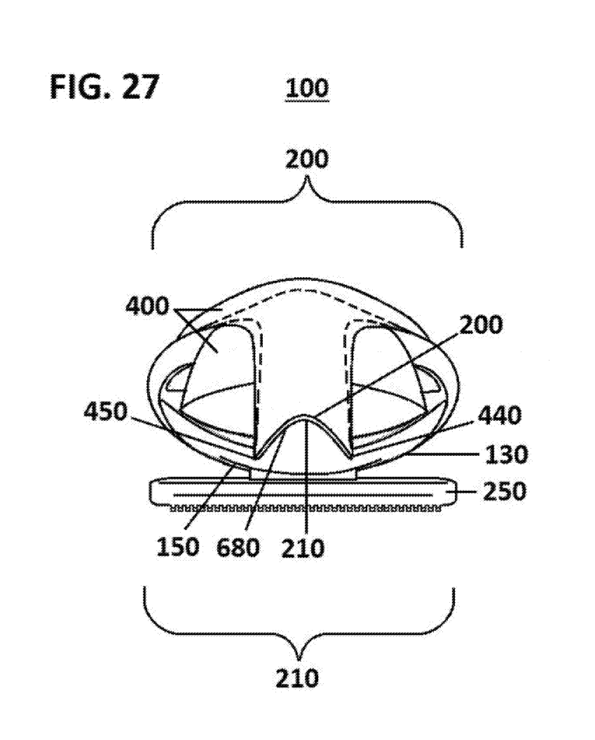

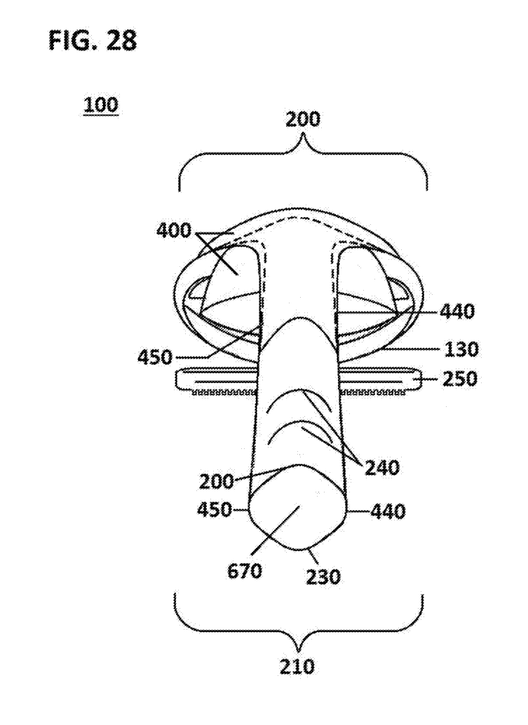

FIGS. 27-28 illustrate rear views cutaway views of an elongated member having a surface along a length of the elongated member 100 defining a left side 440 and a right side 450 a blade end 130 and the left side 440 opposite the right side 450 and the grip end 140 and blade end 130 between the left side 440 and right side 450. A safety razor 250 is not included when referencing the left side 440 and the right side 450 of the two-sided elongated member 100.

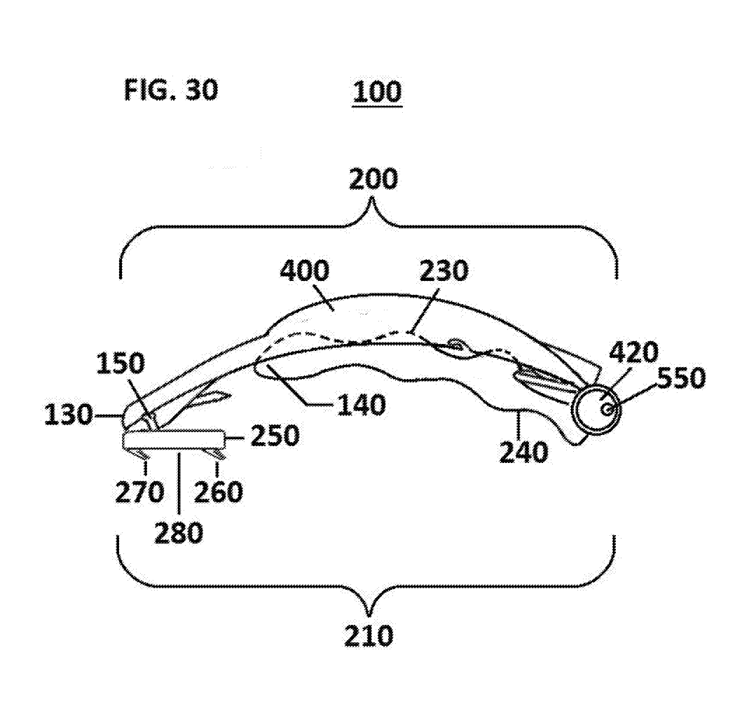

The generally s-shaped elongated member 100 may have a concave shape 680 inside of the blade end 130 and grip 230 which was previously illustrated in the prior FIGS. 1-6. The concave shape allows for the grip 230 portion of the elongated member 100 to enter in the concave shape 680 when the elongated member 100 is folding against itself at approximately 180 degrees which will be further illustrated in the upcoming FIGS. 30-32. This is beneficial when the elongated member 100 is folded against itself and is easier for a user to grasp elongated member 100 when being used to shave easy-to-reach areas of the body such as the shoulder, chest or buttock area. Accessing this shoulder area in this manner will be further illustrated in the upcoming FIG. 32. As seen in FIG. 27 a safety razor 250 attaching to a two-sided back shaver handle with a blade attachment 150. An elongated sponge 400 located in a direction along a length of the elongated member on the outer side 200, wherein the elongated sponge 400 extends longer in a length between the grip 230 and the blade end 130 than a width between the left side 440 and the right side 450.

FIG. 28 is a rear view of an elongated back shaving handle 100 with a cutaway of elongated member 100 illustrating a solid cutaway 670 inside of a grip 230 and a secondary grip 240. Though the solid cutaway 670 may be positioned on alternate areas on the elongated member 100, in FIG. 28 the solid cutaway 670 is approximately midway the length of the elongated member 100 inside of where the grip 230 begins and the hand end. Since FIG. 28 is a cutaway a handle end is not illustrated. However handle end is illustrated in the previous FIGS. 1-6 and FIGS. 10-21.

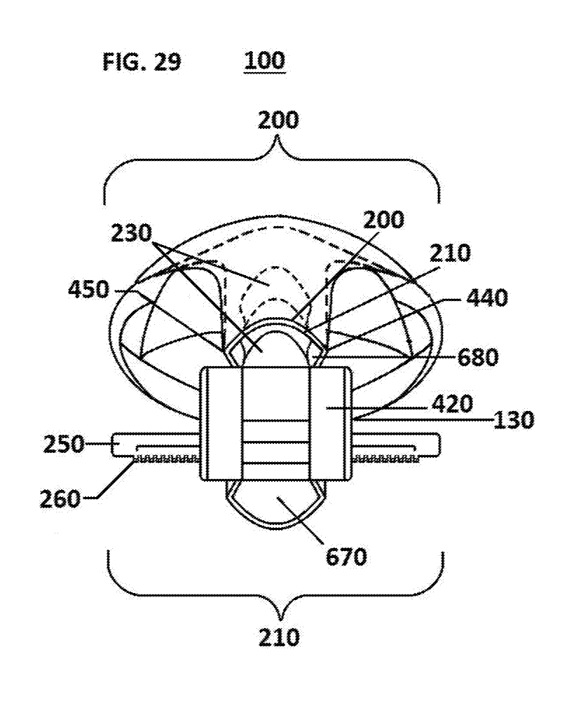

FIG. 29 illustrates a rear view of an elongated handle 100 folded against itself and defining a left side 440 and a right side 450 an inner side 210 and an outer side 200, wherein left side 440 opposite a right side 450 and inner side 210 opposite an outer side 200 and a blade end 130 wherein the blade end 130 is between the left side 440 and right side 450. A safety razor 250 is not included when referencing the left side 440 and the right side 450 of an elongated member 100. An outer side 200 opposite the said inner side 210, and having a finger surface grip 230 that when elongated member 100 is folded against itself said grip 230 is located on the inner side 210 of the elongated member 100 and wherein the inner side 210, the outer side 200, the blade end 130, and the grip end 140 join one another to create an outside surface of the elongated member 100. A safety razor 250 with a blade group 260 located at the blade end 130. A solid cutaway 670 is inside of the grip 230. However handle end is illustrated in the prior FIGS. 1-6, and FIGS. 10-21. It can be seen in FIG. 29 that since elongated back shaver handle 100 is folded against itself a grip 230 is inside of elongated back shaver handle 100 concave shape 680 which is inside of a hinge 420.

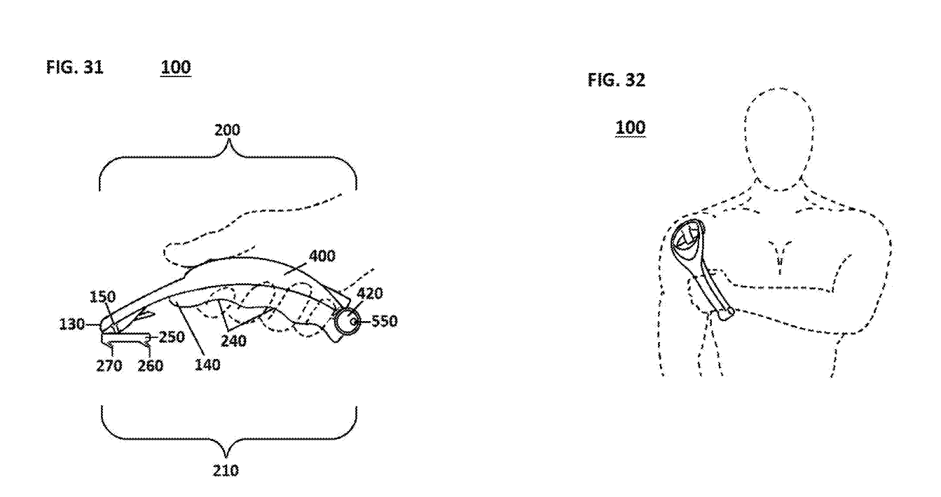

FIG. 30 illustrates a side view of an elongated handle 100 folded against itself and defining an inner side 210 and outer side 200 wherein inner side 210 is opposite outer side 200 and a blade end 130 and a blade attachment 150 near the blade end 130 and the blade attachment 150 attaching a safety razor 250 having a blade group 260 and a blade group 270 and a sensory gap 280 inside of the blade group 260 and blade group 270. An elongated sponge 400 located in a direction along a length of the elongated member on the outer side 200, wherein the elongated sponge 400 extends longer in a length between the hinge 420 and the blade end 130 than a width between the left side 440 and the right side 450 which was illustrated in the previous FIG. 29. It can be seen in FIG. 30 that since elongated back shaver handle 100 is folded against itself a grip 230 is inside of elongated back shaver handle 100 concave shape 680 which is inside of a hinge 420 and the blade end 130. In FIG. 30 hinge 420 having a push button 550. Furthermore, in FIG. 30 it can be seen that a grip end 140 is now directed towards a blade end 130. A secondary grip 240 is now directed towards the inner side 210 of the folded elongated member allowing a user to easily hold the folded member 100 to shave other easy-to-reach areas of the body which will be further illustrated in the upcoming FIGS. 31-32. The blade attachment 150 is a portion of the elongated member 100 near the blade end 130 that attaches to an attachment on the safety razor 250. In order for the blade attachment 150 to properly function there is also an attachment on the safety razor 250 for the elongated member 100 to attach itself to. The blade attachment 150 and a attaching piece on the safety razor may take many different forms to allow both safety razor 250 and elongated member 100 to removably attach with one another.

FIG. 31 illustrates a side view of a user holding an elongated handle 100 folded against itself and defining an inner side 210 and outer side 200 wherein inner side 210 is opposite outer side 200 and a blade end 130 and a blade attachment 150 near the blade end 130 and the blade attachment 150 attaching a safety razor 250 having a blade group 260 and a blade group 270. A user's hand is represented with the dashed lines. An elongated sponge 400 located in a direction along a length of the elongated member on the outer side 200, wherein the elongated sponge 400 extends longer in a length between the hinge 420 and the blade end 130 than a width between the left side 440 and the right side 450 which was illustrated in the previous FIG. 29. It can be seen in FIG. 31 that since elongated back shaver handle 100 is folded against itself a grip 230, previously illustrated in prior FIG. 30, is now inside of elongated back shaver handle 100 concave shape 680 which is inside of a hinge 420 and the blade end 130. In FIG. 31 a hinge 420 having a push button 550. Furthermore, in FIG. 31 it can be seen that a grip end 140 is now directed towards a blade end 130. A secondary grip 240 is now directed towards the inner side 210 of the folded elongated member allowing a user to easily hold the folded member 100 to shave other easy-to-reach areas of the body.

The illustration presented in FIG. 31 is to show how a user's hand would grab a elongated member when said elongated member 100 is folded against itself. Fingers belonging to a user are fitted into a secondary grip 240 which is on the inner side 210 of an elongated member 100 when said elongated member 100 is folded against itself as in FIG. 31. An elongated sponge 400 or soft cushion is a user's palm and a secondary grip 240 allowing an elongated sponge 400 or soft cushion to act as a soft cushion support between the elongated shaver handle 100 and a user's hand.

FIG. 32 illustrates a front view of a user holding an elongated handle 100 folded against itself and a user is holding and using said folded elongated member 100 to shave areas of the body such as the shoulder which commonly has easier access in comparison to accessing the back side of a user to shave.

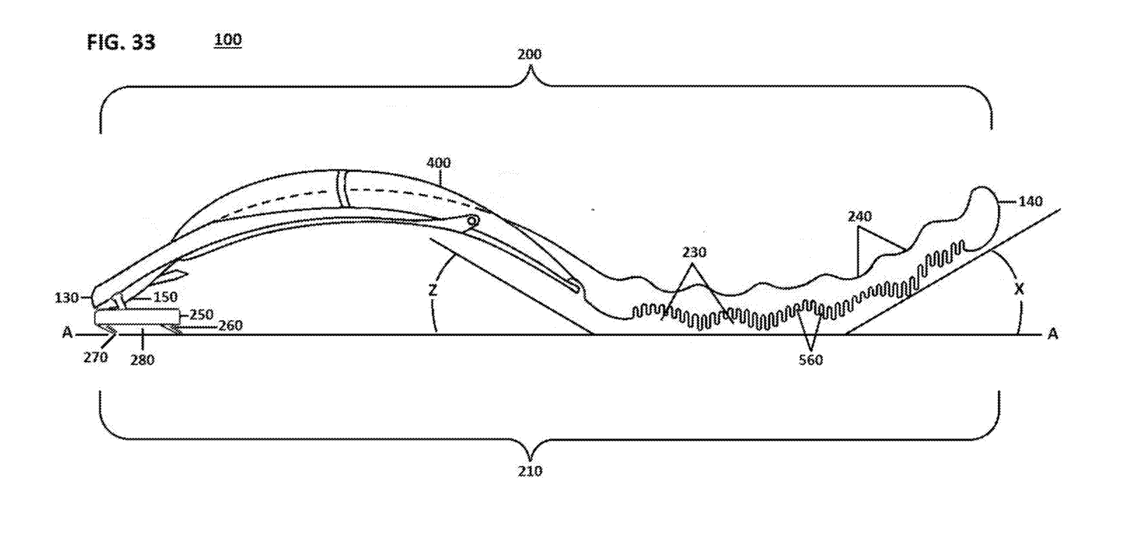

FIG. 33 illustrates a side view of an elongated member with an elongated sponge 400 and a safety razor 250 configured according to embodiments of the present inventions. The elongated member has an elongated member 100 having a surface along a length of the elongated member 100 defining an inner side 210 and an outer side 200, a blade end 130 and a grip end 140. The outer side 200 is opposite the inner side 210 and the grip end 140 is opposite the blade end 130 and between the outer side 200 and the inner side 210. The outer side 200, the inner side 210, the blade end 130, the grip end 140 join one another to create an outside surface of the elongated member 100 that is substantially smooth and a cross-sectional shape of the elongated member near the midway is substantially smooth having a shape that is substantially round or oval and a blade attachment 150 at a blade end 130 of the elongated member 100 opposite the grip end 140. A blade group 260 and blade group 270 are positioned at an angle from a safety razor 250 and may be positioned at a wide range of angles. Blade group 260 and blade group 270 are designed to safely poke and indent into a skin surface A in order to carry out an effective shaving stroke while at the same time performing two-point discrimination. Furthermore, a sensory gap 280 is illustrated in FIG. 33 and serves multiple purposes. The first purpose is to allow balance and stability of the safety razor 250 when stroking against the skin surface. Sensory gap 280 also grants space for a tightened skin to convex and enter inside of the sensory gap 280 allowing a user to maintain an effective angle between blade groups and a skin surface without difficulty. A sensory gap 280 also creates an effective amount of distance between blade group 260 and blade group 270 in order to allow two-point discrimination to occur. The elongated member 100 has a straight length or a length that does not follow the curve of the elongated member 100 but rather that actual distance from the blade end 130 to the grip end 140 which is approximately 330 mm to 457.2 mm. A preferred straight length of the elongated member 100 is approximately 355.6 mm.

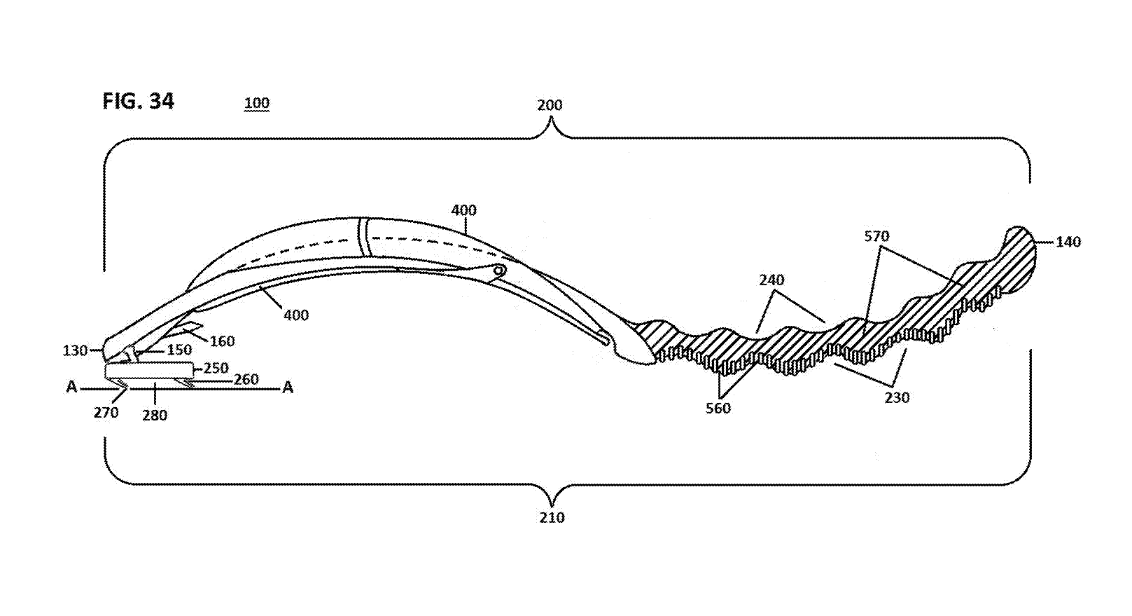

A primary grip 230 comprises a finger surface located on the inner side 210 of the elongated member and grip 240 comprises a finger surface located on the outer side 200 of the elongated member. A grip 230 or 240 is closer in proximity to a grip end 140 of an elongated member 100. A primary grip 230 or a secondary grip 240 is offset beneath a tangent line extending from a central portion of the convex surface contour of the elongated sponge 400 in a direction such that a hand of a user on the grip 230 or 240 does not impinge when extending the elongated sponge 400 onto a torso backside of the user. The finger surface of the grip 230 on the inner side 210 of the elongated member and comprises finger depressions. In FIG. 33 it can be seen that grip 230 has grooves 560 that run inside and along the grip 230 and inside and outside the depressions. The grooves 560 provide additional traction and control when a user is holding grip 230. It will be seen in the upcoming FIG. 34 that the grooves 560 allow for a flexible grip cover to be attached and anchor itself to the exterior of the grip 230 and grip 240.

Letter designations in the drawings depict certain planes, gap distances and contours, defined throughout, and for convenience are summarily defined wherein:
“X” references a handle angle X between the skin plane A and an approximated tangent to the curve of the inner side 210 of the finger surface grip 230 having the grooves 560 near the grip end 140 of the s-shaped elongated handle illustrated in FIG. 33; and
“Z” references a mid angle Z between the planar skin plane A and an approximated tangent to the curve of the inner side 210 of the body leverage surface of the s-shaped elongated handle near a midway of the handle as illustrated in FIG. 33; and

The handle angle X and the mid angle Z are substantially the same and about slightly less than 45 degrees in one preferred embodiment as illustrated in FIG. 33.

FIG. 34 illustrates a side view of an elongated member with an elongated sponge 400 and a safety razor 250 configured according to embodiments of the present inventions. The elongated member has an elongated member 100 having a surface along a length of the elongated member 100 defining an inner side 210 and an outer side 200, a blade end 130 and a grip end 140. The outer side 200 is opposite the inner side 210 and a grip end 140 is opposite the blade end 130 and between the outer side 200 and the inner side 210. The outer side 200, the inner side 210, the blade end 130, the grip end 140 join one another to create an outside surface of the elongated member 100 that is substantially smooth and a cross-sectional shape of the elongated member near the midway is substantially smooth having a shape that is substantially round or oval and a blade attachment 150 at the blade end 130 of the elongated member 100 opposite the grip end 140. A blade group 260 and blade group 270 are positioned at an angle from a safety razor 250 and may be positioned at a wide range of angles. Blade group 260 and blade group 270 are designed to safely poke and indent into a skin surface in order to carry out an effective shaving stroke while at the same time performing two-point discrimination. A sensory gap 280 is illustrated in FIG. 34 which is gap is space inside at least two supports which in FIG. 34 each support is a blade group illustrated as blade group 260 and blade group 270. The first purpose is to allow balance and stability of the safety razor 250 when stroking against the skin surface. Sensory gap 280 also grants space for a tightened skin to convex and enter inside of sensory gap 280 allowing a user to maintain an effective angle between blade groups and a skin surface without difficulty. The sensory gap 280 also creates an effective amount of distance between blade group 260 and blade group 270 in order to allow two-point discrimination to occur.

A primary grip 230 comprises a finger surface located on the inner side 210 of the elongated member and grip 240 comprises a finger surface located on the outer side 200 of the elongated member. A grip 230 and 240 is closer in proximity to a grip end 140 of an elongated member 100. A primary grip 230 or a secondary grip 240 is offset beneath a tangent line extending from a central portion of the convex surface contour of the elongated sponge 400 in a direction such that a hand of a user on the grip 230 and 240 does not impinge when extending the elongated sponge 400 onto a torso backside of the user. The finger surface of the grip 230 on the inner side 210 of the elongated member and comprises finger depressions. In FIG. 34 it can be seen that grip 230 has grooves 560 that run inside and along the grip 230 and inside and outside the depressions. The grooves 560 provide additional traction and control when a user is holding grip 230. It will be seen in FIG. 34 that the grooves 560 allow for a flexible grip cover 570 to enter inside of said grooves 560 in order to attach anchor said grip cover 570 to the exterior of the grip 230 and grip 240. The elongated member 100 has a straight length or a length that does not follow the curve of the elongated member 100 but rather that actual distance from the blade end 130 to the grip end 140 which is approximately 330 mm to 457.2 mm A preferred straight length of the elongated member 100 is approximately 355.6 mm.

FIGS. 35-36 are side views of an s-shaped elongated handle 100 with a safety razor 250 configured according to embodiments of the present inventions. In FIG. 35 the s-shaped elongated handle 100 has a blade end 130 and a grip end 140 and inside the blade end 130 and grip end 140 an opening 740 formed by a shock absorber inside end 730 of a portion of the s-shaped elongated handle 100 and an inside end 700 of the elongated handle 100. A flexible shock absorber 710 positioned near the shock absorber inside end 730 of the s-shaped elongated handle 100 and up to the shock absorber front end 720 of flexible shock absorber 710. An s-shaped elongated member 100 having a surface along a length of the s-shaped elongated member 100 defining an inner side 210 and an outer side 200, a blade end 130 and a grip end 140. The outer side 200 is opposite the inner side 210. The blade end 130 is between the inner side 210 and the outer side 200. The inner side 210 having a finger surface grip 230 located on the inner side of the s-shaped elongated member 100 and the s-shaped elongated member 100 may have a secondary grip 240 on the outer side 200. The grip end 140 is opposite the blade end 130 and between the outer side 200 and the inner side 210. The blade attachment 150 comprises a handle clip 160 used to removably attach a safety razor 250 in the said blade attachment 150. The safety razor 250 having a blade group 260 and blade group 270 at an angle from the inner side 210 of the s-shaped elongated handle 100 with a sensory gap 280 inside of said blade group 260 and blade group 270. A body leverage surface 220 is located on the outer side 200 of the s-shaped elongated member 100 near a midway between the grip 230 and the blade end 130 and said blade end 130 configured to press the body leverage surface 220 against a user's forearm when the grip 230 is respectively gripped by fingers and hand by a same arm of the user located on the inner side 210 of the s-shaped elongated member.

A flexible shock absorber 710 near a hinge 420 midway of the elongated member and a flexible shock absorber 710 configured to absorb pressure created between the blade attachment 150 and a user's backside when a shaving stroke is made. In FIGS. 35-36 the flexible shock absorber 710 near an shock absorber inside end 730 of s-shaped elongated handle 100. In an alternate embodiment the shock absorber front end 720 of a flexible shock absorber 710 may be positioned closer to the blade end 130. In yet another embodiment a flexible shock absorber 710 may be positioned inside of the grip end 140 and the shock absorber inside end 730 of the elongated handle 100. In FIGS. 35-36 the shock absorber front end 720 of the flexible shock absorber 710 is inside of the body leverage surface 220 and the hinge 420. In FIG. 35 the s-shaped elongated handle 100 is not in a temporary locked position with the hinge 420 and is loose. In FIG. 35 the grip end 140 is being brought closer to the outer side 200 of the handle in order for the hinge 420 to temporarily lock the s-shaped elongated handle 100 into an unfolded position for a user to use to shave. It can be seen in FIG. 35 that the shock absorber inside end 730 has not made contact with the inside end 700 of the s-shaped elongated member 100 and an opening is inside of shock absorber inside end 730 and the inside end 700 of the two-sided member 100. In FIG. 36 the grip end 140 has moved closer to the outer side 200 of the s-shaped elongated handle 100 and the hinge 420 is temporarily locking the s-shaped elongated member 100 into place and the s-shaped elongated handle 100 is ready to use to shave. It can be seen in FIG. 36 that when the shock absorber inside end 730 of the flexible shock absorber 710 makes contact with the inside end 700 of the s-shaped elongated handle 100 is pressing against the flexible shock absorber 710 granting the flexibility of the flexible shock absorber 710 once the s-shaped elongated handle 100 is unfolded into a position sufficient for holding and shaving. When force is applied to the blade attachment 150 the flexible shock absorber 710 is absorbing the pressure. Bumps are commonly found on one's backside and it can be said that during the shaving process it would be helpful to absorb many of the bumps in order that a shaving stroke is not interrupted during the process. A flexible shock absorber 710 may flex and retract and shifting the grip end 140 at alternate angles. The hinge 420 in FIGS. 35-36 is located near the shock absorber inside end 730 the flexible shock absorber 710. It alternate embodiments the location of the hinge 420 may be altered to create the same effect. In FIGS. 35-36 the hinge 420 having a push button 550 as illustrated in prior FIGS. 27-28 and FIG. 33. The flexible shock absorber 710 is configured so that it need not be removed when folding the s-shaped elongated handle 100. It another embodiment the flexible shock absorber 710 may be on the outer side 200 or the inner side 210 of the grip 230 or grip 240 while the hinge 420 may be closer to the blade end 130 opposite the grip end 140.

Although the invention is described herein with reference to specific embodiments, various modifications and changes can be made without departing from the scope of the present inventions as set forth in the claims below. Accordingly, the specification and figures are to be regarded in an illustrative rather than a restrictive sense, and all such modifications are intended to be included within the scope of the present inventions. They can have different configurations than the examples illustrated in the drawings. Any benefits, advantages, or solutions to problems that are described herein with regard to specific embodiments are not intended to be construed as a critical, required, or essential feature or element of any or all the claims.

Any letter designations such as (a) or (b) etc. used to label steps of any of the method claims herein are step headers applied for reading convenience and are not to be used in interpreting an order or process sequence of claimed method steps. Any method claims that recite a particular order or process sequence will do so using the words of their text, not the letter designations.

Unless stated otherwise, terms such as “first” and “second” are used to arbitrarily distinguish between the elements such terms describe. Thus, these terms are not necessarily intended to indicate temporal or other prioritization of such elements.

1. A two-sided back shaver handle, comprising:
an elongated member having a surface along a length of the elongated member defining an inner side, an outer side, a left side, a right side, a blade end, and a handle end and the outer side opposite the inner side, the left side between the inner side and the outer side, the right side opposite the left side and between the outer side and the inner side;
a grip at the handle end of the elongated member;
a blade attachment at the blade end of the elongated member, the blade end located at an end of elongated member opposite the handle end, the blade attachment located on the inner side of the elongated member; and
sponge wrapped around the elongated member on the outer side.

2. A two-sided back shaver handle according to claim 1, wherein the sponge is located on the outer side of the elongated member closer to the blade end than the grip end.

3. A two-sided back shaver handle according to claim 1, wherein the elongated member comprises a generally s-shaped elongated member with a convex surface contour on the outer side between the grip and the blade end.

4. A two-sided back shaver handle according to claim 3, wherein the sponge has a shape that conforms to the convex surface contour of the outer side of the s-shaped elongated member.

5. A two-sided back shaver handle according to claim 4, wherein the grip is offset beneath a tangent line extending from a central portion of the convex surface contour of the sponge in a direction such that a hand of a user on the grip does not impinge when extending the sponge onto a torso backside of the user.

6. A two-sided back shaver handle according to claim 4, wherein the grip comprises a finger surface located on the inner side of the s-shaped elongated member.

7. A two-sided back shaver handle according to claim 6, the finger surface of the grip is on the inner side of the elongated member and comprises finger depressions.

8. A two-sided back shaver handle according to claim 1, wherein the sponge comprises a strap wrapped around the elongated member.

9. A two-sided back shaver handle according to claim 8, wherein an end of the strap of the sponge comprises a fastener to fasten the end of the strap back against the sponge when the strap is wrapped around the elongated member.

10. A two-sided back shaver handle according to claim 1, wherein the sponge comprises at least one strap for attachment on the elongated member.

11. A two-sided back shaver handle according to claim 10, wherein the elongated member comprises a hook located to catch the strap for attachment of the sponge.

12. A two-sided back shaver handle according to claim 1, wherein the sponge comprises at least one elastic strap for attachment on the elongated member.

13. A two-sided back shaver handle according to claim 1, wherein the sponge has characteristics capable of holding a skin care product.

14. A two-sided back shaver handle according to claim 1, wherein the blade attachment attaches to a blade cartridge with at least one blade group with a sharp edge of at least one sharp blade on the inner side of the elongated member facing against the torso backside of the user.

15. A two-sided back shaver handle according to claim 1, wherein the sponge comprises an elongated sponge longer in a length between the grip and the blade end than a width between the left side and the right side.

16. A two-sided back shaver handle according to claim 1, further comprising a hinge near the midway of the elongated member between the grip and the blade attachment configured to fold the elongated member.

17. A two-sided back shaver handle according to claim 16, wherein the hinge moves to fold the elongated member back against itself for storage.

18. A two-sided back shaver handle according to claim 16, wherein the hinge moves approximately 180 degrees to completely fold the elongated member back against itself for storage and reduce a length of the elongated member by approximately half.

19. A two-sided back shaver handle according to claim 16, wherein the hinge comprises a finger trigger configured as a lock and release system for said hinge.

20. A two-sided back shaver handle according to claim 1, wherein the sponge is wrapped around the elongated member on the outer side along a length of the elongated member.

21. A two-sided back shaver handle according to claim 1, wherein the inner side, the outer side, the left side and the right side join one another to create an outside surface of the elongated member that is substantially smooth.

22. A two-sided back shaver handle according to claim 1, wherein a cross-sectional shape of the elongated member near a midway is substantially smooth having a shape that is substantially round or oval.

23. A two-sided back shaver handle according to claim 1, wherein each of two leverage surfaces are at corresponding high points of each of each corresponding part of the “S” shape of handle.

24. A two-sided back shaver handle according to claim 1, further comprising an opening inside a left side and right side of a handle inside blade end and a midpoint of the elongated member to allow the sponge to attach to the outer surface of the elongated member.

25. A two-sided back shaver handle according to claim 1, wherein the sponge attaches to both the inner side and outer side of the elongated member.

26. A method of using a two-sided back shaver, the method comprising the steps of:
(a) obtaining a two-sided back shaver comprising
an elongated member having a surface along a length of the elongated member defining an inner side, an outer side, a left side, a right side, a blade end, and a handle end and the outer side opposite the inner side, the left side between the inner side and the outer side, the right side opposite the left side and between the outer side and the inner side;
a grip at the handle end of the elongated member;
a blade at the blade end of the elongated member, the located at an end of elongated member opposite the handle end, the blade located on the inner side of the elongated member; and
sponge wrapped around the elongated member on the outer side;
(b) grasping the grip of the two-sided back shaver obtained in said step (a);
(c) reaching the two-sided back shaver towards a back side after grasping in said step (b);
(d) sponging against the back side with the sponge while continuing the reaching of the two-sided back shaver towards a back side of said step (c);
(e) rotating the two-sided back shaver from the sponge facing the back side to the blade facing the back side after the sponging of said step (d) while continuing the reaching of the two-sided back shaver towards a back side of said step (c); and
(f) shaving the blade against the back side after the rotating of said step (e) while continuing the reaching of the two-sided back shaver towards a back side of said step (c).
